(19) United States
(12) Patent Application Publication
(10) Pub. No.: US 2020/0389239 A1
(43) Pub. Date: Dec. 10, 2020

(54) PROFILE EVALUATION FOR USER DEVICE

(71) Applicant: Comcast Cable Communications, LLC, Philadelphia, PA (US)

(72) Inventors: Maurice Manuel Garcia, Levittown, PA (US); Olakunle Ekundare, Sicklerville, NJ (US)

(21) Appl. No.: 16/435,937

(22) Filed: Jun. 10, 2019

(51) Int. Cl. H04B 17/373; H04B 17/391; H04L 29/08; H04B 17/382; H04L 1/20

(52) U.S. Cl. CPC H04B 17/373; H04B 17/3913; H04L 1/203; H04B 17/382; H04L 67/303

(57) ABSTRACT

Systems, apparatuses, and methods are described for evaluating profiles used for communication with a user device. A computing device may receive a signal associated with a profile. The computing device may analyze the received signal, and may determine, based on the analysis of the received signal, a simulation configuration associated with the profile. A simulation associated with the profile may be performed. The computing device may request or cause, based on the simulation, a change of the profile.

### BACKGROUND

Data may be transmitted, based on parameters stored or indicated in one or more profiles, in a downstream channel or an upstream channel. Data streams may be transmitted over noisy transmission channels. Data communications using some profiles may be more vulnerable to interference and/or noise in different transmission channels. Selecting appropriate profiles for different noisy channel environments may be difficult.

### SUMMARY

The following summary presents a simplified summary of certain features. The summary is not an extensive overview and is not intended to identify key or critical elements.

Systems, apparatuses, and methods are described for evaluating profiles used for communication with a user device. A computing device in a network may receive a signal generated based on one or more profiles. The computing device may analyze the received signal and may configure a simulation setting to evaluate the one or more profiles and/or one or more unused profiles. The computing device may perform a simulation associated with a selected profile, and evaluate the selected profile using the simulation results. One or more simulated evaluation parameters may be used to predict vulnerability of communications based on one or more profiles. In addition to the analysis results of the received signal, the one or more simulated evaluation parameters may be used in evaluating one or more profiles.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3 shows an example communication network providing multiple profiles to a plurality of user device groups.

FIG. 4A shows an example of an orthogonal frequency-division multiplexing (OFDM) signal based on a plurality of modulation profiles and being transmitted to a user device group.

FIG. 4B shows an example of a plurality of profiles.

FIG. 5 shows an example termination system.

FIG. 6 shows an example user device.

FIG. 7 shows an example user device communicating with a termination system.

FIG. 8 shows an example of a forward error correction (FEC) process for a received OFDM signal.

FIG. 9 shows an example profile simulator.

FIG. 10 shows an example of a simulated FEC process for a received OFDM test signal.

FIG. 11 is a flow chart showing an example method for evaluating one or more modulation profiles.

FIG. 12 is a flow chart showing an example method for evaluating one or more profiles based on one or more simulated evaluation parameters.

FIG. 13 shows an example of components of an upstream signal processor.

FIG. 14 shows an example of a termination system providing multiple modulation profiles to user devices.

FIG. 15 shows an example network of devices used to provide one or more modulation profiles to user devices.

FIG. 16 shows an example distribution of signal to noise ratio at user devices that may be used to determine one or more modulation profiles.

FIG. 17 shows an example of signal ingress and its effect on error ratio.

FIG. 18 shows at least a portion of a method for determining one or more data modulation profiles for groups of devices.

FIG. 19 shows examples of a plurality of subcarriers for one or more devices.

FIG. 20 shows an example of detecting skew for determining signal ingress.

FIG. 21 shows an example of detecting skew for determining signal ingress.

FIG. 22 shows at least a portion of a method for determining one or more data modulation profiles for groups of devices.

FIG. 23 shows an example of determining one or more standard deviations for one or more subcarriers.

FIG. 24 shows an example of determining one or more standard deviations for each user device's MER for one or more devices in a group.

FIG. 25 shows at least a portion of a method for determining one or more data modulation profiles for groups of devices.

FIG. 26 shows an example of determining one or more data modulation profiles for one or more devices in a group.

FIG. 27 shows an example of assigning modulation profiles.

FIG. 28 shows an example of spectrum data from a device in the network.

FIG. 29 shows an example of channelized spectrum data.

FIG. 30 shows an example of MER (e.g., OFDM MER) versus frequency.

FIG. 31 shows an example of OFDM analysis using non-OFDM devices.

FIG. 32 shows an example of a subcarrier count per modulation order.

FIG. 33 shows an example of MER distribution of a single OFDM channel.

FIG. 34 shows an example of standard deviation of MER versus percentile of a single OFDM channel.

FIG. 35 shows at least a portion of a method for determining one or more data modulation profiles for a device or a group of devices.

FIG. 36 shows at least a portion of a method for determining one or more data modulation profiles for a device or a group of devices.

FIG. 37 shows an example of bitload thresholds.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

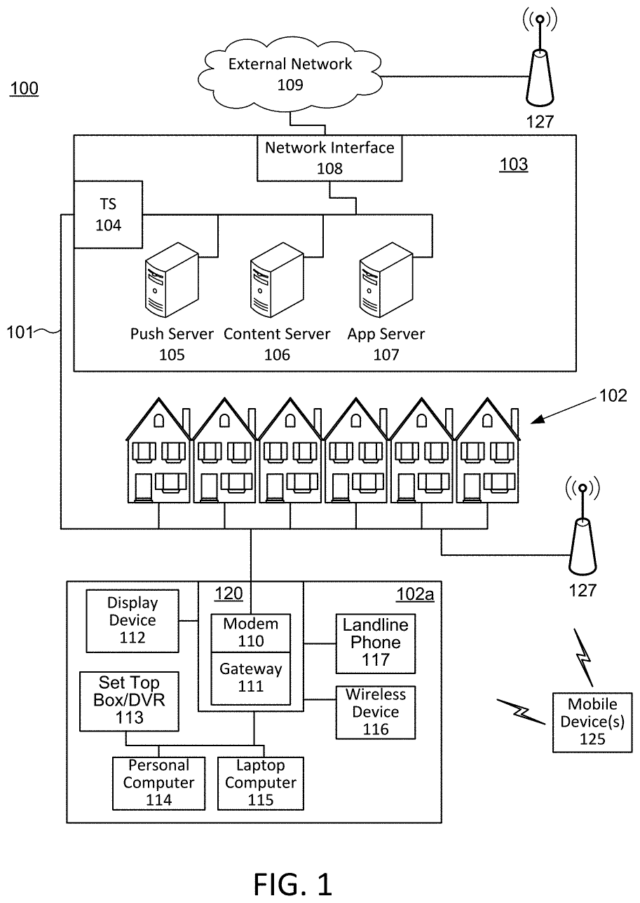

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104, such as a termination system (TS). The interface 104 may comprise a cable modem termination system (CMTS) and/or other computing device(s) configured to send information downstream to, and to receive information upstream from, devices communicating with the local office 103 via the communications links 101. The interface 104 may be configured to manage communications among those devices, to manage communications between those devices and backend devices such as servers 105-107, and/or to manage communications between those devices and one or more external networks 109. The local office 103 may comprise one or more network interfaces 108 that comprise circuitry needed to communicate via the external networks 109. The external networks 109 may comprise networks of Internet devices, telephone networks, wireless networks, wireless networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The content server 106 may generate content data to be transmitted to devices in the premises 102 and/or to the mobile devices 125. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional push, content, and/or application servers, and/or other types of servers. Although shown separately, the push server 105, the content server 106, the application server 107, and/or other server(s) may be combined. The servers 105, 106, and 107, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), STBs or DVRs 113, personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g. Voice over Internet Protocol—VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

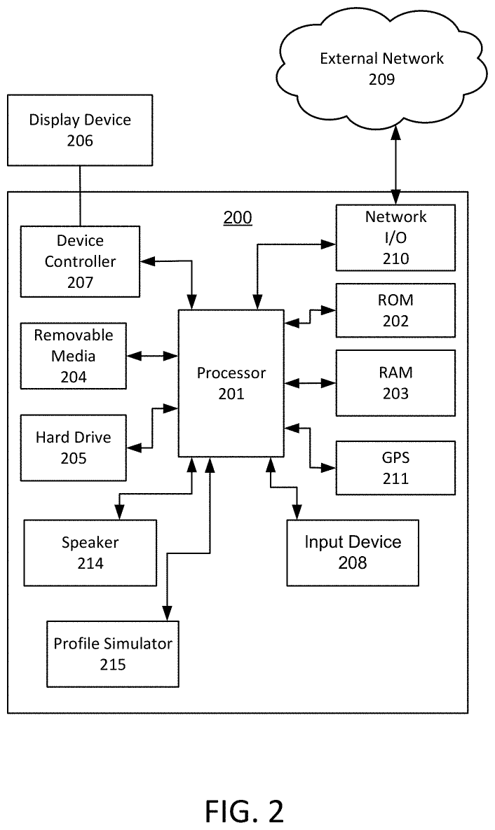

FIG. 2 shows hardware elements of a computing device 200 that may be used to implement any of the computing devices shown in FIG. 1 (e.g., the modem 110, the gateway 111, the mobile devices 125, any of the devices shown in the premises 102a, any of the devices shown in the local office 103, any of the wireless access points 127, any devices with the external network 109) and any other computing devices discussed herein (e.g., the TS 104, the push server 105, the content server 106, the application server 107, the modem 110, the gateway 111, the set-top box/DVR 113, the personal computer 114, the laptop computer 115, the wireless device 116, the mobile device 125, the wireless access point 127, the termination system 305, one or more user devices of the user device group 315, the user devices 500, 600, and 620, etc.). The computing device 200 may comprise one or more processors 201, which may execute instructions of a computer program to perform any of the functions described herein. The instructions may be stored in a read-only memory (ROM) 202, random access memory (RAM) 203, removable media 204 (e.g., a USB drive, a compact disk (CD), a digital versatile disk (DVD)), and/or in any other type of computer-readable medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

The computing device 200 may comprise a profile simulator 215. The computing device 200 (e.g., a cable modem, a TS, etc.) may comprise the profile simulator 215 in a form of a firmware, a reference design kit (RDK), etc. The profile simulator 215 may comprise one or more software components and/or hardware components for signal processing and/or simulation described herein. A profile may comprise one or more modulation profiles used to modulate or demodulate a signal, one or more error correction profiles used to perform an error correction of a received signal, an encoding/decoding profile used to encode or decode data and/or other data. A profile may comprise data specifying one or more communication parameters (e.g., modulation type and/or order, and/or error correction type(s), and/or coding type(s), and/or other parameters indicating how data is to be transmitted) or sets of parameters, and may comprise various channels/frequencies/times that those parameters should be used. The profile simulator 215 may simulate and evaluate one or more profiles. The computing device 200 may transmit or receive modulated signals via the external network 209. The modulated signals may be modulated using one or more modulation profiles. Each modulation profile may comprise different modulation schemes (e.g., Quadrature Amplitude Modulation (QAM), quadrature phase shift keying (QPSK), binary phase shift keying (BPSK), etc.) Each profile may also comprise different error correction schemes (e.g., Reed-Solomon (RS) forward error correction (FEC), Low-density parity-check (LDPC) code, Bose-Chaudhuri-Hocquenghem (BCH) code, etc.). The profile simulator 215 may comprise a hardware component (e.g., a firmware) that communicates with the processor 201 and/or a software component (e.g., an RDK) to simulate and evaluate one or more profiles. The simulation may comprise one or more processes that use the one or more profiles (e.g., simulated encoding and modulating of a test code or a test signal). For example, cable modems may receive downstream signals from a termination system (e.g., a CMTS) via an HFC network. The downstream signal may be modulated using one or more modulation profiles. The termination system and/or the cable modems may comprise and use a profile simulator 215 to evaluate one or more modulation profiles so that the termination system and/or the cable modems may determine, before experiencing a serious degradation of the communication quality, a better set of profiles (e.g., one or more modulation profiles, one or more encoding profiles, etc.) for future communications between the termination system and the cable modems.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer. One or more components of the computing device 200 or other devices described herein may be merged in a single hardware component or may be implemented as separate hardware components.

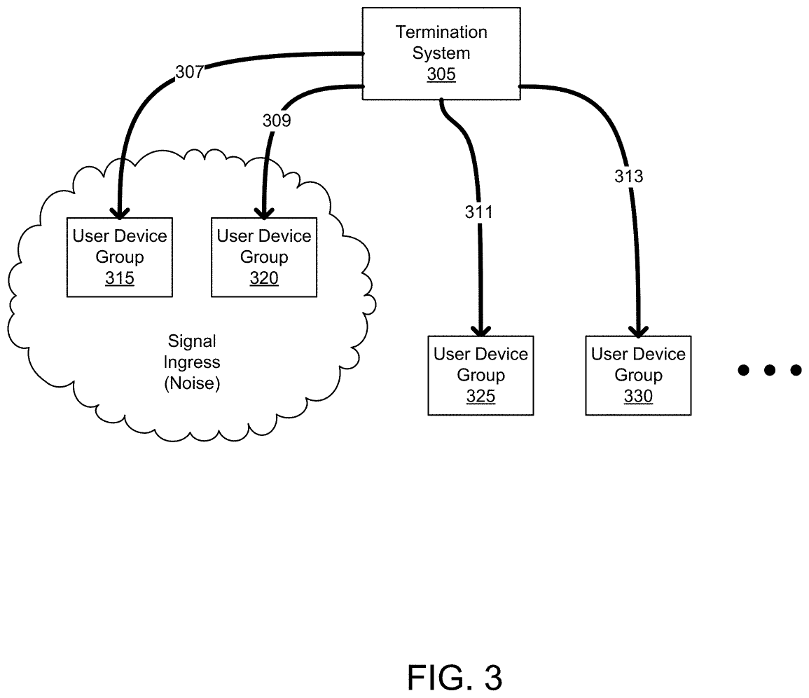

FIG. 3 shows an example communication network providing multiple profiles to a plurality of user device groups. For example, the termination system 305 may provide a first set of profiles 307 to a user device group 315 and a second set of profiles 309 to a user device group 320. The first set of profiles 307 and the second set of profiles 309 may comprise different sets of modulation profiles. When the first set of profiles 307 and the second set of profiles 309 have different sets of modulation profiles, at least one modulation profile may be commonly comprised in both the first set of profiles 307 and the second set of profiles 309 (or there may be no common modulation profile). The termination system 305 may send the same set of modulation profiles to two (or more) user device groups. The termination system 305 may similarly provide the same or different sets of profiles to other device groups, such as the profiles 311 to the user device group 325, the profiles 313 to the user device group 330, and other profiles to other user device groups (not shown).

The termination system 305 may provide more robust profiles (e.g., lower order modulation profiles, such as 256 QAM instead of 4096 QAM, and/or error correction profiles with more error correction bits) to user device groups experiencing signal ingress or other noise, such as the user device group 315 and the user device group 320. Signal ingress may comprise noise caused by wireless communications, such as long-term evolution (LTE) signals, 5^{th} generation mobile network (5G) signals, global system for mobile communications (GSM) signals, etc. Ingress signals may comprise impulse signals, non-impulse signals, long duration signals (e.g., hours of static carriers), or any other noise signal that affects the upstream and/or downstream signal quality between the termination system 305 and the user device groups 315 and 320.

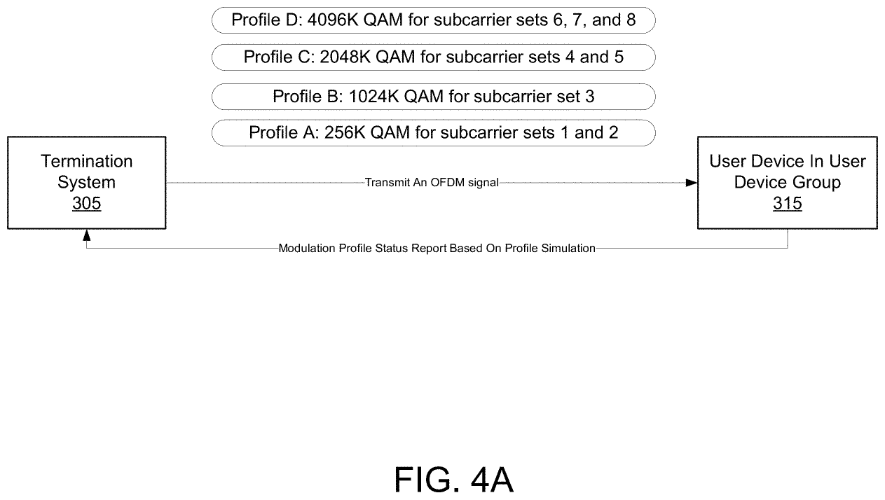

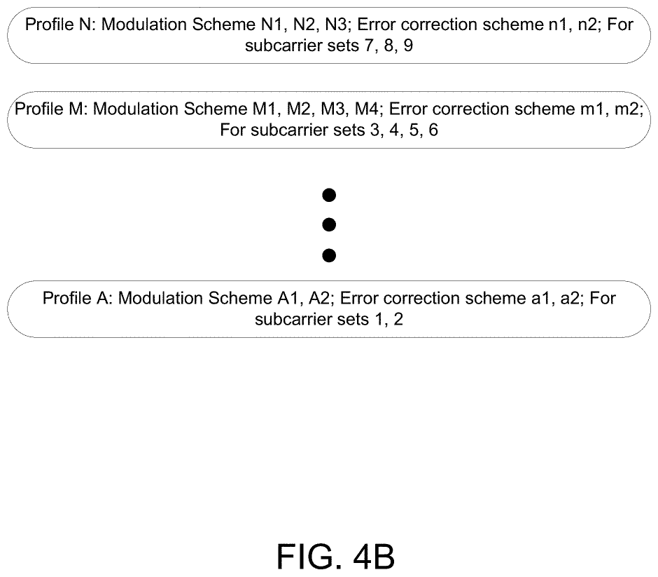

FIG. 4A shows an example of an orthogonal frequency-division multiplexing (OFDM) signal based on a plurality of modulation profiles and being transmitted to a user device group. The termination system 305 may send downstream signals modulated based on a plurality of modulation profiles. The plurality of modulation profiles may be determined by the termination system 305 for the user device group 315. The termination system 305 may use OFDM and different modulation profiles may be used for one or more subcarriers.

For example, a profile A (e.g., 256 QAM) may be used for a first group of subcarriers (e.g., subcarrier sets 1 and 2), a profile B (e.g., 1024 QAM) may be used for a second group of subcarriers (e.g., subcarrier set 3), a profile C (e.g., 2048 QAM) may be used for a third group of subcarriers (e.g., subcarrier sets 4 and 5), and a profile D (e.g., 4096 QAM) may be used for a fourth group of subcarriers (subcarrier sets 6, 7, and 8). The user device group 315 may receive the downstream signals and analyze the quality of the received downstream signals.

Each of one or more user devices of the user device group 315 may perform a simulation for one or more of the modulation profiles used for the downstream signals, for example, based on an analysis of the received downstream signals. Each of the one or more user devices may send a modulation profile status report based on the simulation. The termination system 305 may configure a same set of modulation profiles (e.g., profiles A, B, C, and D) for the user device group 315, and the user device group 315 may receive OFDM signals modulated based on the same set of modulation profiles. One or more user devices of the user device group 315 may perform a profile simulation and send, to the termination system 305, a modulation profile status report. If the simulation indicates that an RF impairment would degrade a quality of service if communications are based on the higher profile (e.g., the profile D), the user device group 315 may report the simulation result to the termination system 305 so that the termination system 315 may communicate based on a lower profile (e.g., the next highest profile: the profile C) or may stop using the profile D in generating downstream signals to one or more user devices of the user device group 315. The termination system 315 may send more important messages, such as Media Access Control (MAC) messages, via the profile A to provide robust quality of services even when an RF impairment occurs.

The modulation profiles may comprise Data Over Cable Service Interface Specification (DOCSIS) OFDM modulation profiles, and the user device group 315 may comprise cable modems (CMs). Although examples relating to DOCSIS networks are discussed, methods, apparatuses, and systems described herein can also or alternatively be used for other types of networks. One or more OFDM frequency subcarrier error ratios, such as a modulation error ratio (MER) and/or signal to noise ratio (SNR), may be evaluated, for one or more subcarriers for one or more devices in the user device group 315, to determine specific modulation types and/or orders. BPSK, QPSK, and/or QAM may be selected for modulation orders. Example modulation orders for QAM may comprise, but are not limited to, 16 QAM, 64 QAM, 256 QAM, 512 QAM, 1024 QAM, 2048 QAM, 4096 QAM, 8192 QAM, 16384 QAM, etc.

A computing device (e.g., the termination system 305, one or more user devices of the user device group 315, or other computing devices communicating with the termination system 305 or the user device group 315) may determine the best profile(s) for the subcarriers based on a number of subcarriers (N), and also based on one or more grouping of carriers for a given device (e.g., modem) population. One or more computing devices of a system (e.g., the termination system 305, one or more user devices of the user device group 315, or other computing devices communicating with the termination system 305 or the user device group 315) may group devices together that have similar response characteristics in order to assign the devices a particular profile to maximize throughput of the grouped devices. The devices that fit within a common characteristic (e.g., MERs of the grouped devices are not significantly deviated from each other, the standard deviation of the MERs may be less than or equal to one standard deviation from a mean, etc.) may be grouped together and assigned a profile and a group of channels.

Interference (e.g., signal ingress, such as LTE signal ingress) may lower the MER for one or more frequencies or frequency bands. The termination system 305 may lower the modulation order for devices using certain subcarriers affected by signal ingress. One or more user devices of the user device group 315 may measure their downstream and/or upstream signal qualities (e.g., MERs) and send the measurements to the termination system 305 or other back end device.

FIG. 4B shows an example of a plurality of profiles. For a downstream or an upstream transmission between two computing devices, a plurality of profiles A, B, C, . . . , and N may be used. Each profile may comprise one or more modulation schemes for one or more frequency and time resources. For example, profiles A, B, C, . . . , and N may be modulated using an OFDM modulation scheme. Each of the profiles may be applied to different sets of subcarriers. For example, the profile A may be applied for subcarrier sets 1 and 2, the profile M may be applied for subcarrier sets 3, 4, 5, and 6, and the profile N may be applied for subcarrier sets 7, 8, and 9. Two or more subcarrier sets may be adjacent to each other or may be non-contiguous along the frequency axis. For example, the subcarrier set 7 may correspond to frequency range of 24 MHz to 30 MHz, the subcarrier set 8 may correspond to frequency range of 30 MHz to 40 MHz, and the subcarrier set 9 may correspond to frequency range of 100 MHz to 110 MHz.

One or more of the profiles may be used during certain time periods. An OFDM symbol may have a unit time length. For example, an OFDM symbol may have a duration of 40 μs, and the profiles N and M may be used alternately along the time axis (e.g., the profile N may be used for OFDM symbols having OFDM symbol indexes 0, 2, 4, . . . , N, and the profile M may be used for OFDM symbols having OFDM symbol indexes 1, 3, 5, . . . , N+1). One or more profiles may be used for OFDM symbols having certain OFDM symbol indexes. For example, the profile A may be used for OFDM symbols having OFDM symbol indexes 1 and 2.

Each profile may comprise a plurality of modulation schemes. For example, the profile A may comprise OFDM and 256 QAM. The profile M may comprise modulation schemes other than OFDM, such as Discrete Multi Tone (DMT) modulation. For example, four different modulation schemes M1, M2, M3, and M4 may be comprised in the profile M. Each profile may comprise different error correction schemes. For example, the profile M may comprise error correction schemes such as the LDPC and/or BCH, and the profile N may comprise different error correction schemes, such as the Reed Solomon.

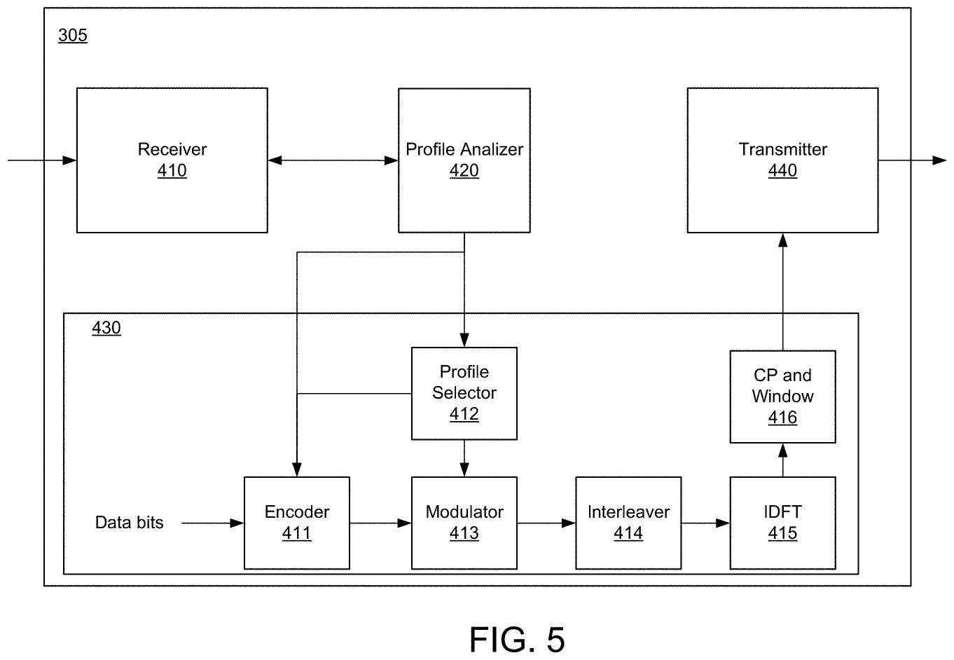

FIG. 5 shows an example termination system. The termination system 305 (e.g., the termination system 104) may comprise a receiver 410, a profile analyzer 420, a signal processor 430, and a transmitter 440. One or more components of the termination system 305 may be implemented as part of the termination system 305 or may be implemented as separate computing devices that communicate with the termination system 305. For example, the profile analyzer 420 may be configured (e.g., based on stored instructions) to operate as a standalone device or part of a computing device (e.g., a modem or a TS) configured to perform other operations, etc. A computing device (e.g., a cable modem or a TS) may comprise the profile analyzer 420 in a form of a firmware, a reference design kit (RDK), etc. The signal processor 430 may comprise a downstream signal processor. The receiver 410 may receive an upstream signal from one or more user devices (e.g., cable modems), telemetry devices, or other devices. The receiver 410 may receive an upstream signal via a wired (e.g., HFC network) and/or wireless networks (e.g., mobile networks). The receiver 410 may receive a report comprising an indication of preferred profiles for one or more user devices. The report may be received from the one or more user devices or from the telemetry devices. The telemetry devices (not shown) may receive and store various simulation data, analysis data, network impairment data, proactive network management (PNM) data, etc. from various devices. Such data may be used by the telemetry device, the termination system 305, or other devices to determine preferred modulation profiles for one or more devices. The telemetry devices may be comprised in the termination system 305 or configured as separate devices.

The profile analyzer 420 may receive the report and analyze the report to determine one or more preferred profiles for one or more user devices. For example, the profile analyzer 420 may determine to change 4096 QAM to 2048 QAM based on a report that the 4096 QAM would cause a certain quantity of uncorrectable errors if the transmitter 440 continues to use the 4096 QAM modulation. The profile analyzer 420 may communicate with a profile selector 412 to change, update, replace, or modify one or more profiles. Based on a report that another error correction scheme is preferred for the one or more user devices, the profile analyzer 420 may determine to change, update, replace, or modify a current error correction scheme used for a particular user device. The profile analyzer 420 may communicate with an encoder 411 to change, update, replace, or modify one or more error correction schemes. Examples of the profile analyzer 420 will be described in more detail.

The signal processor 430 may comprise the encoder 411, the profile selector 412, a modulator 413, an interleaver 414, an Inverse Discrete Fourier Transform (IDFT) processor 415, and a CP and window processor 416. One or more components of the signal processor 430 may be implemented as part of the termination system 305 or may be implemented as separate computing devices that communicate with the termination system 305.

The encoder 411 may comprise an FEC encoder, such as an LDPC encoder and a BCH encoder to encode received data bits into encoded codewords. The BCH encoder may be an outer coder that encodes received data bits and the LDPC encoder may be an inner encoder that receives and encodes the output of the BCH encoder. For example, the BCH encoder may receive 14,232 data bits and add 368 redundant bits on data payload of the 14,232 bits. The LDCP may insert an additional 1,800 check bits (e.g., the LDPC code rate may be 8/9) and may generate codewords with a length of 16,200 bits. The encoded codewords may further be shuffled via bit interleaving.

The modulator 413 may comprise a QAM mapper and/or other types of modulation mappers. The modulator 413 may determine bit-loading schemes based on one or more modulation profiles selected by the profile selector 412. The codewords output by the encoder 411 may be modulated by the modulator 413 and may be mapped into OFDM symbols. Each subcarrier in an OFDM symbol may have a different QAM modulation. The modulator 413 may also perform one or more processes of randomization, next codeword pointer (NCP) insertion, NCP FEC, and/or NCP constellation mapping with randomization in accordance with one or more technical schemes, such as, for example, technical schemes specified in DOCSIS® 3.1 Physical Layer Specification CM-SP-PHYv3.1-I07-150910.

The interleaver 414 may comprise a time interleaver and a frequency interleaver. Codewords and/or the modulated signals may be interleaved in time and frequency, in order to mitigate the impact of burst noise and the effect of signal ingress. The time interleaver may disperse subcarriers of an input symbol over a set of output symbols. This time interleaving may mitigate a noise burst on an OFDM symbol because this burst is spread over the output symbols when it is de-interleaved. The frequency interleaver may perform a frequency interleaving before or after the time interleaving. The frequency interleaving may disperse subcarriers of symbols along the frequency axis.

The IDFT processor 415 may transform each OFDM symbol into a time domain sequence using one or more inverse discrete Fourier transforms (IDFT). The CP and window processor 416 may append a cyclic prefix to the time domain sequence output by the IDFT processor 415. For windowing purposes, a roll-off period (RP) may be appended to the time domain sequence. After the CP and window processes, the CP and window processor 415 may output a CP and window processed sequence to the transmitter 440. The transmitter 440 may receive the output of the CP and window processor 416 and may send a radio frequency (RF) signal generated from the CP and window processed sequence. The radio frequency signal may be communicated to one or more user devices as one or more downstream signals. The downstream signals may comprise multimedia data and/or communication data.

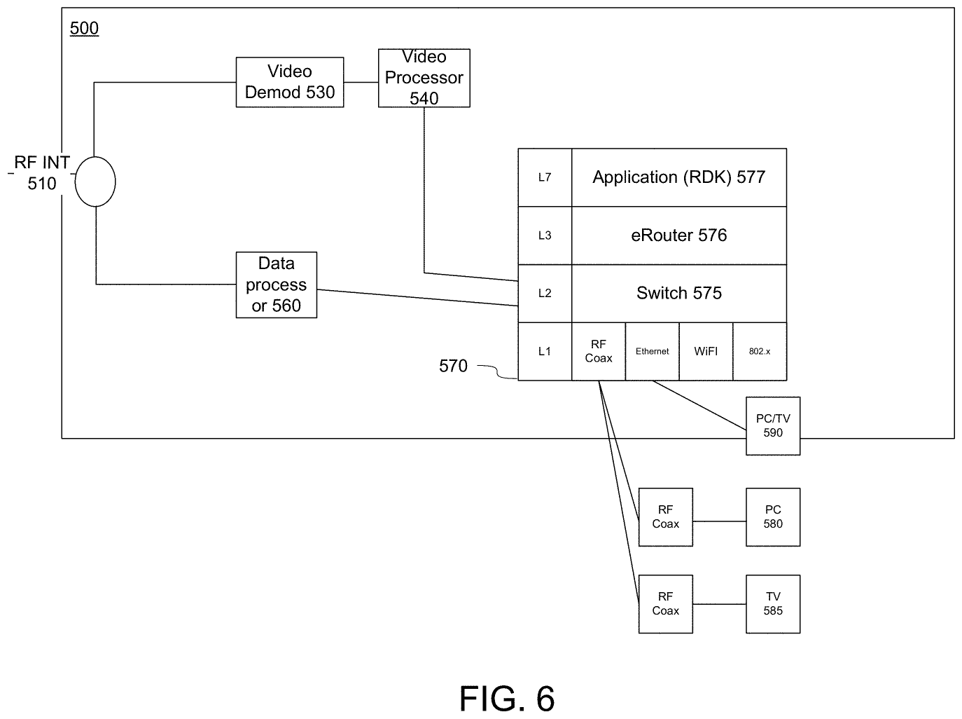

FIG. 6 shows an example user device. The user device 500 may comprise one or more of the modem 110 (e.g., a cable modem), the gateway 111, the set-top box/DVR 113, the display device 112, etc. The user device 500 may send or receive an RF signal via an RF interface 510. For example, the user device 500 may receive, via a video demodulator 530, a multimedia downstream signal comprising the multimedia data. The video demodulator 530 may demodulate the received multimedia downstream signal to multimedia data. A video processor 540 may process the multimedia data (e.g., decoding the multimedia data), and provide the processed multimedia to user terminals, such as the display device 112, the wireless device 116, the personal computer 114, the laptop computer 115, the mobile devices 125, and/or TVs 585 and 590, via a gateway device 570. The gateway device 570 may provide functionalities of cable modems and set-top boxes.

Downstream and upstream communication data may be communicated via a data processor 560. For example, the data processor 560 may receive, from the RF interface 510, downstream data signals comprising the communication data and forward the downstream data signals to the gateway device 570. The data processor 560 may receive, from the gateway device 570, upstream data signals comprising communication data and forward the upstream data signal to the RF interface 510. The switch 575 may be a layer-2 switch and may process the switching between the multimedia data associated with the video processor 540 and the communication data associated with the data processor 560.

The application layer 577 may comprise an RDK. One or more components of the profile simulator 215 may be implemented using the RDK in the application layer 577. The profile simulator 215 may perform one or more simulations for modulation profiles used for the multimedia data and/or the communication data.

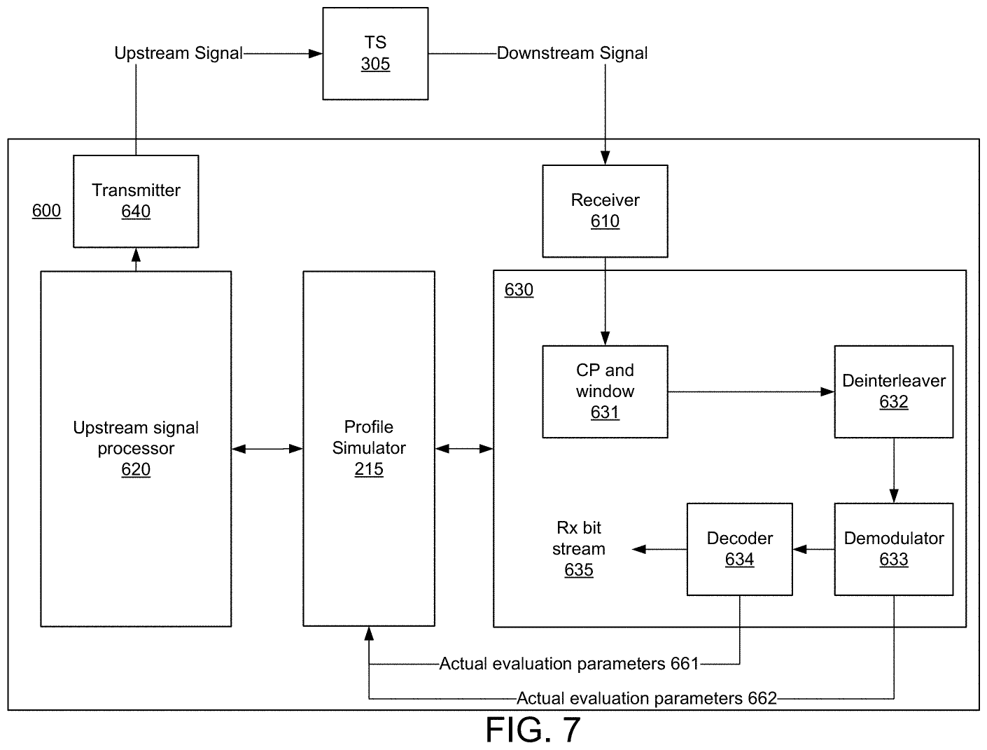

FIG. 7 shows an example user device communicating with a termination system. The user device 600 may be the modem 110, the gateway 111, the set-top box/DVR 113, or one or more of the modem 110, the gateway 111, or the set-top box/DVR 113. One or more components of the user device 600 may perform (e.g., based on instructions) one or more operations of the user device 600 described herein, and the one or more operations may be performed by one or more of the modem 110, the gateway 111, the set-top box/DVR 113, or any other user device. The user device 600 may communicate with the termination system 305 via a network (e.g., a Hybrid fiber-coaxial (HFC) network). The user device 600 may comprise one or more of the components of the user device 500 shown in FIG. 6 and/or may have different components. The user device 600 may be implemented in a cable modem, a set-top box, etc. The user device 600 may comprise a receiver 610, a signal processor 630, the profile simulator 215, an upstream signal processor 620, and a transmitter 640. The signal processor 630 may comprise a downstream signal processor.

The receiver 610 may receive downstream signals from the termination system 305 via the network. The receiver 610 may receive signals modulated based on DOCSIS 3.1 protocols and/or other protocols (e.g., DOCSIS 3.0). The downstream signals may comprise signals modulated using an OFDM modulation scheme and/or other modulation schemes. The termination system 305 may determine a plurality of profiles and generate the downstream signals using the plurality of profiles.

The signal processor 630 may comprise a CP and window processor 631, a deinterleaver 632, a demodulator 633, and a decoder 634. The demodulator 633 may comprise a QAM slicer. The decoder 634 may comprise an FEC decoder (e.g., a concatenation of an LDPC decoder and a BCH decoder). After the decoding process of the decoder 634, the signal processor 630 may obtain a received bit stream 635. The bit stream 635 may be processed by the signal processor 630 or other processor of the user device 600. The bit stream 635 may comprise data, such as multimedia data, communication data, control data, instructions from the termination system 305, etc.

The CP and window processor 631 may remove the cyclic prefix and remove window from the signal received from the receiver 610. The deinterleaver 632 may perform frequency deinterleaving and time deinterleaving processes. The demodulator 633 may receive the deinterleaved signal from the deinterleaver 632 and may determine codewords by demodulating the deinterleaved signal. The decoder 634 may receive the codewords from the demodulator 633 and may perform decoding of the codewords. The decoder 634 may perform error correction and determine the Rx bit stream 635. The processes performed by the CP and window processor 631, the deinterleaver 632, the demodulator 633, and the decoder 634 may be the inverse processes of the processes performed by the signal processor 430.

Communications between the termination system 305 and the user device 600 may be evaluated via Proactive Network Management (PNM) and/or a Profile Management Application (PMA), and the termination system 305, the user device 600, and/or a separate evaluation system may determine the best OFDM profile or profiles for communications between the termination system 305 and the user device 600. A direct correlation and/or causation of MER versus QAM modulation profile may be analyzed. By determining the worst MER per subcarrier, the average MER per subcarrier, and/or the best MER per subcarrier, the termination system 305 may create dynamic profiles for a given user device (or a user device group). For a given user device (or a user device group), the termination system 305 may assign multiple profiles. Profiles may be created dynamically so that the user device 600 can be assigned with one or more profiles that facilitate the best data performance for that user device 600.

The PNM may be supported by one or more of the termination system 305 and the user device 600, and the PNM may enable the termination system 305 and/or the user device 600 to measure and report network conditions such that undesired impacts (e.g., plant equipment and cable faults, interference from other systems and ingress) can be detected and measured. With the PNM measurement data, one or more modifications of various network parameters, such as changing the modulation profiles, may be performed to improve conditions and monitor the network trends.

For the PNM processes, the termination system 305 and/or the user device 600 may comprise a spectrum analyzer, a vector signal analyzer, and a network analyzer. For example, the profile analyzer 420 of FIG. 5, the profile simulator 215 of FIG. 7, and/or other elements of the termination system 305 and/or the user device 600 may perform the PNM processes. The PNM processes may be implemented to improve throughput and reliability of service. The termination system 305 and the user device 600 may perform the PNM measurements while in service, without suspending or affecting normal operations or data transmission/reception.

The termination system 305 may analyze equalizer coefficients, impulse noise statistics, FEC statistics, etc. The user device 600 may analyze downstream symbols, a full-band spectrum, pre-equalizer coefficients, a downstream channel estimate, a downstream noise power ratio (NPR) measurement, a constellation display, Receive MER (RxMER) per subcarrier, FEC statistics, etc. For example, the user device 600 may send, to the profile simulator 215, these data obtained from the various measurements as evaluation parameters (e.g., actual evaluation parameters 661 and 662, PNM data, etc.). These evaluation parameters may be used by the user device 600 to evaluate the one or more profiles.

One or more of the evaluation parameters may also or alternatively be used by the profile simulator 215 as simulation configuration parameters (e.g., one or more simulation inputs and/or one or more values for a simulation configuration setting). For example, the RxMER per subcarrier may also be used as a simulation configuration parameter to determine an estimated channel for the simulation of one or more profiles associated with the corresponding subcarrier.

The downstream NPR measurement may indicate the noise, interference and intermodulation products underlying a portion of a downstream OFDM signal. For example, an LTE interference occurring within an OFDM band and/or an intermodulation products resulting from signal-level alignment may be analyzed.

The user device 600 may determine downstream channel estimate coefficients so that the user device 600 may report its estimate of the downstream channel response. The reciprocals of the channel response coefficients may be used by the user device 600 as its frequency-domain downstream equalizer coefficients. The user device 600 may determine a channel estimate, which may comprise one or more complex values per subcarrier. The user device 600 may also determine a noise on the downstream channel and add the noise to the channel estimate. For example, the user device 600 may add, to the channel estimate, additive white Gaussian noise (AWGN) per subcarrier.

The downstream constellation display may provide received QAM constellation points for display. The user device 600 may capture and report received soft-decision samples, for a single selected constellation from the set of profiles it is receiving within a single OFDM downstream channel.

The user device 600 may measure the RxMER for each subcarrier using pilots and physical layer link channel preamble symbols. The RxMER may be measured as a ratio of average power of an ideal QAM constellation to average error-vector power. The error vector may be a difference between an equalized received pilot or preamble value and a known correct pilot value of preamble value. The RxMER may also be measured by one or more other known mathematical formula for defining the RxMER.

The user device 600 may measure downlink FEC statistics as a type of the evaluation parameters. The FEC statistics may comprise FEC codeword error data. For example, LDPC error correction statistics and BCH error correction statistics may be generated for each OFDM channel and for each modulation profile being received by the user device 600. If the user device 600 is receiving communications transmitted based on 4 downstream profiles, there may be 4 sets of FEC counters and a set of counters for the transition profile used for an OFDM downstream profile test. For the profiles 1 to 4, statistics for data codewords may comprise all codewords. For the transition profile, statistics for data codewords may comprise either all codewords or only some of marked codewords.

For each profile, the user device 600 may determine total number of FEC codewords, the number of correctable codewords, and the number of uncorrectable codewords. The correctable codewords may comprise codewords that failed pre-decoding LDPC syndrome check and passed BCH decoding. The uncorrectable codewords may comprise codewords that failed BCH decoding. For each profile, the user device 600 may determine NCP cyclic redundancy check (CRC) failures and total number of NCP fields. For example, for the NCP codewords, the NCP CRC failures may be the number of NCP fields that failed CRC check. The user device 600 may also determine the number of uncorrectable codewords and total number of codewords in a particular time interval.

The user device 600 may determine performance characteristics of physical link channel (PLC) codewords. For example, the user device 600 may determine unreliable PLC codewords and total number of PLC codewords. The unreliable PLC codewords may be the number of codewords that failed LDPC post-decoding syndrome check.

For each profile, the user device 600 may determine performance characteristics on MAC frames addressed to the user device 600. For example, the user device 600 may determine MAC frame failures and total number of MAC frames. The MAC frame failures may be the number of frames that failed MAC CRC check.

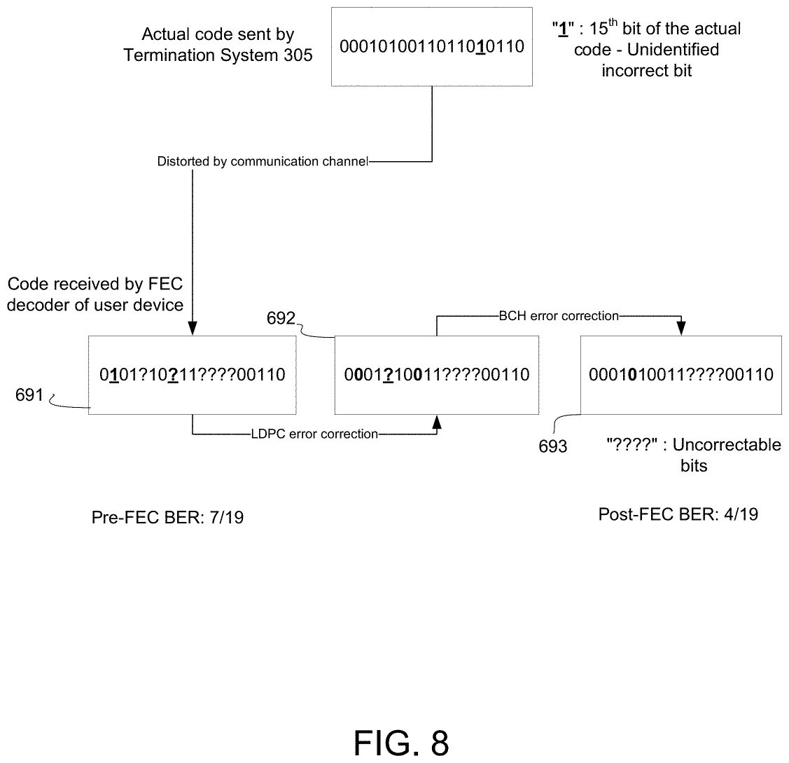

FIG. 8 shows an example of an FEC process for a received OFDM signal. For example, the decoder 634 of FIG. 7 may perform an LDPC error correction and a BCH error correction such as is shown in FIG. 8. A code 691 may be processed by an LDPC decoder. One or more iterations of the LDPC decoder may correct the second bit “1” to “0” and the unidentifiable 8^{th} bit to “0” and may generate a first corrected code 692. The first corrected code 692 may still have one or more uncorrectable bits (e.g., the bits marked with “?”). The first corrected code 692 may be processed by a BCH decoder. The BCH decoder may correct one or more bits of the first corrected code 692 that were not corrected by the LDPC decoder. For example, the 5^{th} bit of the first corrected code 692 may be corrected to bit “0” and the BCH decoder may generate a second corrected code 693. The code 691 before the LDPC error correction may have 7 incorrect or unidentifiable bits out of 19 total bits. Thus, a pre-FEC bit error ratio (BER) may be 7/19. The second corrected code 693 after the LDPC and BCH error corrections may have 4 uncorrectable or unidentifiable bits out of 19 total bits.

LDPC may see across the entire bandwidth and look for codeword errors instead of bit errors. If codeword errors are correctable, LDPC may automatically make adjustments to correct the codeword so that higher modulations can be obtained. This may reduce the need for retries and facilitate subcarriers use of at optimal levels. LDPC may be designed to allow data to be transmitted at its theoretical limits.

As LDPC makes real-time adjustments, it can reach its limits regarding power levels and MER while trying to correct codewords. This may mean that LDPC may give less warning of impending failure. If LDPC goes over this limit, codewords can become uncorrectable and the performance of LDPC may degrade. To predict when LDPC may become ineffective and or to reduce the degradation of the LDPC performance, one or more simulations based on one or more evaluation parameters may be performed.

Various error correction statistics, as evaluation parameters, may be reported to the profile simulator 215. Evaluation data of the report may comprise other data (e.g., a profile analysis report based on the one or more evaluation parameters) in addition to the evaluation parameters. For example, the number of iterations of the LDPC decoder in correcting the code 691 may be reported to the profile simulator 215. The profile simulator 215 may receive other evaluation parameters from the signal processor 630 or other components of the user device 600. The profile simulator 215 may also or alternatively perform one or more operations to determine the various evaluation parameters.

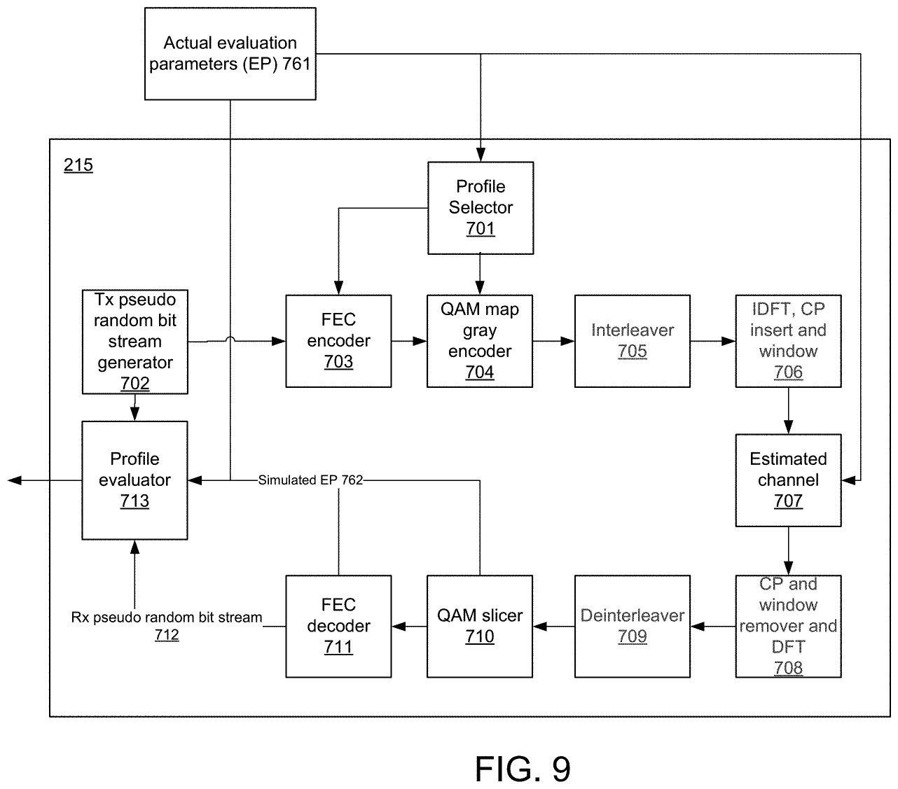

FIG. 9 shows an example profile simulator. The profile simulator (e.g., the profile simulator 215) may comprise a profile selector 701, a transmit (Tx) pseudo random bit stream generator 702, an FEC encoder 703, a QAM map gray encoder 704, an interleaver 705, IDFT/CP/Window processor 706, a channel estimator 707, a CP/Window/DFT processor 708, a deinterleaver 709, a QAM slicer 710, an FEC decoder 711, and a profile evaluator 713. One or more of the components of the profile simulator may be implemented as part of the profile simulator or may be implemented as separate computing components (e.g., firmware, software modules, computing devices, etc.) that communicate with the profile simulator. The profile simulator 215 may receive actual evaluation parameters 761 to configure simulation settings (e.g., one or more simulation configurations). The actual evaluation parameters 761 may comprise the actual evaluation parameters 661 and 662 (see FIG. 7) and PNM data, such as an RxMER for each subcarrier. Based on an analysis of the actual evaluation parameters 761, the channel estimator 707 may determine an estimated channel (e.g., a channel estimate). The estimated channel may comprise AWGN determined based on one or more of the actual evaluation parameters 761.

The profile selector 701 may select, based on the analysis of the actual evaluation parameters 761, one or more profiles for simulation. For example, the profile selector 701 may select each one of a plurality of profiles being used for a downstream signal that is received by the user device 600. The profile selector 701 may select one or more profiles currently not being used for the downstream signal. For example, the user device 600 may currently be receiving a downstream OFDM signal modulated based on 256 QAM, 512 QAM, 1024 QAM, and 4096 QAM. The profile selector 701 may select 2048 QAM for simulation to test the hypothetical performance of 2048 QAM in the current estimated channel.

The Tx pseudo random bit stream generator (TRBS) 702 may select and/or generate a transmit pseudo random bit stream (TxPRBS) as a test code. The Tx PRBS generator 702 may provide the TxPRBS to the FEC encoder 703 and the profile evaluator 713. The profile simulator 215 may perform encoding and modulating of the test code as if the profile simulator 215 is generating a downstream OFDM signal (e.g., the downstream OFDM signal generated by the signal processor 430 of the termination system 305). The FEC encoder 703, the QAM map gray encoder 704, the interleaver 705, and the IDFT/CP/Window processor 706 may be example components of the encoding and modulating of the test code. For example, the FEC encoder 703 may perform an FEC encoding of the test code to generate encoded codewords. The encoding may be performed after selecting one or more encoding profiles. One or more encoding schemes may be selected for the FEC encoding. For example, the FEC encoding may comprise a sequence of BCH encoding and LDPC encoding. Based on a selected profile, one or more other encoding schemes may be selected for FEC encoding.

One or more modulation profiles (e.g., 512 QAM, 4096 QAM, etc.) may be selected for modulating data. The profile QAM map gray encoder 704 may modulate, based on one or more selected modulation profiles, the codewords encoded by the FEC encoder 703. The modulation may comprise QAM mapping and gray encoding. The interleaver 705 may interleave the modulated signal output form the QAM map gray encoder 704. The IDFT/CP/Window processor 706 may perform an IDFT process and a CP and window insertion and may generate a Tx downstream test signal. Although not shown in FIG. 9, other processes of generating a downstream signal (e.g., a downstream OFDM signal in accordance with DOCSIS 3.1) may be additionally performed.

The channel estimator 707 may receive the Tx downstream test signal, which may pass through the estimated channel. The channel estimator 707 may estimate a channel, based on one or more EPs 761 (e.g., PNM data comprising downstream channel estimate coefficients, RxMER per subcarrier) that are associated with the selected profile. The Tx downstream test signal may be more distorted by the estimated channel, for example, if the selected profile comprises a higher-level QAM (e.g., 4096 QAM). The channel estimator 707 may output receive (Rx) downstream test signal determined based on the Tx downstream test signal and the estimated channel. For example, the Tx downstream test signal may comprise values of a Tx downstream signal sequence, and the values of the TX downstream signal sequence may be multiplied with a channel matrix of the estimated channel. The estimated channel may replicate the channel status between the termination system 305 and the user device 600. The channel estimation may be performed periodically, on a real-time basis, and/or on other bases.

By passing the Tx downstream test signal via the estimated channel, the channel estimator 707 may obtain the Rx downstream test signal. The CP/Window/DFT processor 708, the deinterleaver 709, the QAM slicer 710, and the FEC decoder 711 may be example components for demodulating and decoding of the Rx downstream test signal. This simulated demodulating and decoding processes may replicate the demodulating and decoding, of the actually received downstream signal, performed by the signal processor 630 of the user device 600. The CP/Window/DFT processor 708 may remove the CP and window from the Rx downstream test signal. The CP/Window/DFT processor may perform a discrete Fourier transform, for example, after the CP and window removal. The deinterleaver 709 may perform a deinterleaving process, for example, after receiving an output signal of the CP/Window/DFT processor 708. The QAM slicer 710 may perform a demodulation process based on an output signal of the deinterleaver 709. The demodulation process may comprise a QAM slicing. The FEC decoder 711 may perform an FEC decoding based on an output signal of the QAM slicer 710. The FEC decoder 711 may obtain an Rx PRBS 712 and provide the Rx PRBS 712 to the profile evaluator 713.

The profile evaluator 713 may generate one or more profile evaluation results. The profile evaluator 713 may receive and analyze the actual evaluation parameters 761 to generate the profile evaluation results. The profile evaluator 713 may receive and analyze simulated evaluation parameters 762 output from the FEC decoder 710 and/or a demodulator (e.g., the QAM slicer 711) to generate the one or more profile evaluation results. The profile evaluator 713 may compare the Tx PRBS and Rx PRBS to compute a simulated BER as part of the one or more profile evaluation results.

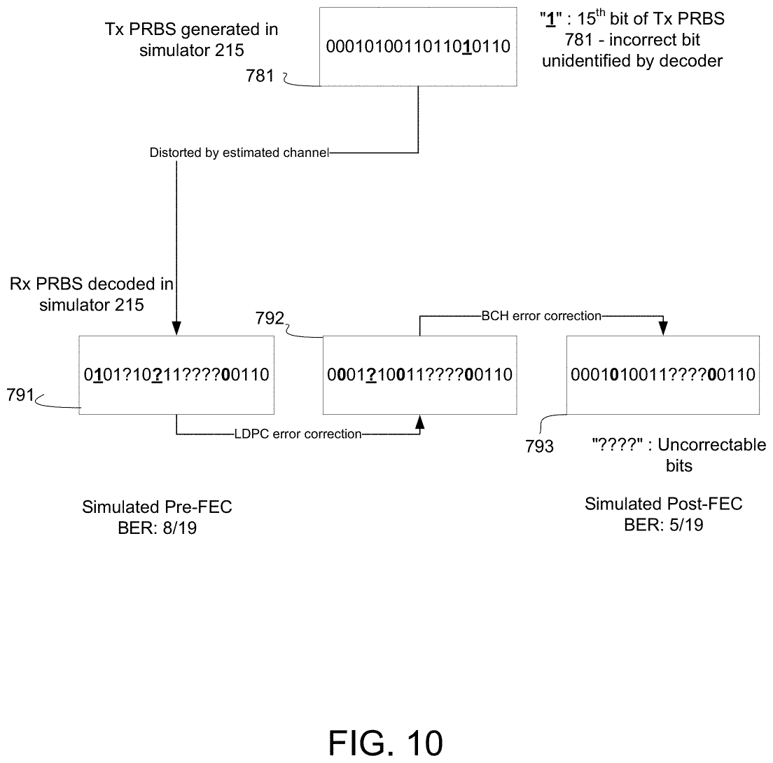

FIG. 10 shows an example of a simulated FEC process for an Rx OFDM test signal. In step 711 of FIG. 9, an LDPC error correction and a BCH error correction may be performed for the Rx OFDM test signal. A simulation code 791 may be obtained after a demodulation process (e.g., by the QAM slicer 710 of FIG. 9). The FEC decoder may process the simulation code 791 (e.g., processed by an LDPC decoder of the profile simulator 215). One or more iterations of the LDPC decoder of the profile simulator 215 may correct the second bit “1” to “0” and the unidentifiable 8^{th} bit to “0” and may generate a first corrected simulation code 792. The first corrected simulation code 792 may still have one or more uncorrectable bits (e.g., the bits marked with “?”). The first corrected simulation code 792 may be processed by a BCH decoder of the profile simulator 215. The BCH decoder may correct one or more bits of the first corrected simulation code 792 that were not corrected by the LDPC decoder. For example, the 5^{th} bit of the first corrected simulation code 792 may be corrected to bit “0” and the BCH decoder may generate a second corrected simulation code 793. The simulation code 791, the first corrected simulation code 792, and/or the second corrected simulation code 793 may be compared with the test code 781 (e.g., the Tx PRBS generated in step 702 of FIG. 9). Based on the comparison, the profile simulator 215 may identify one or more additional incorrect bits (e.g., the 15^{th} bit of the test code 781). For example, the simulation code 791 before the LDPC error correction may have 8 error bits out of 19 total bits (e.g., 2^{nd}, 5^{th}, 8^{th}, 11^{th}, 12^{th}, 13^{th}, 14^{th}, and 15^{th} bits may be incorrect bits or unidentifiable bits). Thus, a pre-FEC bit error ratio (BER) may be 8/19. The second corrected simulation code 793 after the LDPC and BCH error corrections may have 5 error bits out of 19 total bits (e.g., 11^{th}, 12^{th}, 13^{th}, 14^{th}, and 15^{th} bits may be incorrect bits or unidentifiable bits).

The profile simulator 215 may compare the test code 781 (the Tx PRBS) and one of the simulation codes 791, 792, and 793 to compute the simulated BER. The simulated BER may identify more unidentifiable bit errors and may be higher than the pre-FEC BER or the Post-FEC BER shown in FIG. 8. Although FIG. 8 and FIG. 10 show that the example codes 691, 692, and 693 and the example simulation codes 791, 792, and 793 are identical, respectively, the example codes 691, 692, and 693 may be different from the example simulation codes 791, 792, and 793 depending on different selections of the test code 781.

Based on the generated profile evaluation results by the profile evaluator 713 of FIG. 9, the profile simulator 215 may determine that a profile change is recommended to avoid future downstream signal impairments. The user device 600 may send, to the termination system 305, a report indicating that the profile change is recommended. The report may comprise one or more of the generated profile evaluation results, and the report may comprise one or more of the evaluation parameters and/or the simulated evaluation parameters. The profile simulator 215 and/or the profile evaluator 713 may predict occurrence of non-correctible error(s), for example, based on one or more simulated evaluation parameters (e.g., the simulated BER). The occurrence of non-correctible error(s) may be more likely, for example, if more unidentifiable bit errors are predicted by using the simulated evaluation parameters.

The profile simulator 215 may determine whether the simulated BER satisfies a threshold BER value (e.g., whether the simulated BER exceeds the threshold BER value). If the simulated BER satisfies the threshold BER value, the user device 600 may determine that the simulated profile needs to be modified or replaced with another profile in generating future downstream signals. The simulated LDPC statistics (e.g., the number of iterations by the simulated LDPC error correction process, the number of corrected codewords by the simulated LDPC error correction process, and the number of uncorrectable codewords by the simulated LDPC error correction process) may also be compared with one or more threshold values. The simulated BCH statistics (e.g., the number of corrected codewords by the simulated BCH error correction process, and the number of uncorrectable codewords by the simulated BCH error correction process) may also be compared with one or more threshold values. If the simulated LDPC and/or BCH statistics satisfy the corresponding threshold values, the user device 600 may determine that the simulated profile needs to be modified or replaced with another profile in generating future downstream signals. The user device 600 may report such determinations (or recommendations) to the termination system 305 so that the termination system 305 may modify or replace the simulated profile.

Simulated evaluation parameters (e.g., simulated evaluation parameters 762) may be compared with actual evaluation parameters (e.g., actual evaluation parameters 761). The profile simulator 215 may compare the simulated BER with one or more BERs computed by the decoder 634. If the difference between the simulated BER with one or more BERs computed by the decoder 634 satisfies a threshold BER value, the user device 600 may send a report to the termination system 305 to indicate the comparison result. Other simulated evaluation parameters (e.g., the simulated LDPC statistics, the simulated BCH statistics, etc.) may be compared with other actual evaluation parameters (e.g., the LDPC statistic by the decoder 634, the BCH statistics by the decoder 634). Based on the comparison between the simulated evaluation parameters and the actual evaluation parameters, the user device 600 may generate a report indicating the comparison result. The user device 600 may send, to the termination system 305, the report.

The profile analyzer 420 of FIG. 5 may analyze the reports sent from the user device 600 and determine, based on the analysis, one or more profile changes. For example, the reports may comprise one or more recommendations for a modulation profile being used by the termination system 305 and/or one or more recommendations for a modulation profile currently not being used by the termination system 305. The profile analyzer 420 may also analyze received evaluation parameters and/or received simulated evaluation parameters to determine the profile changes.

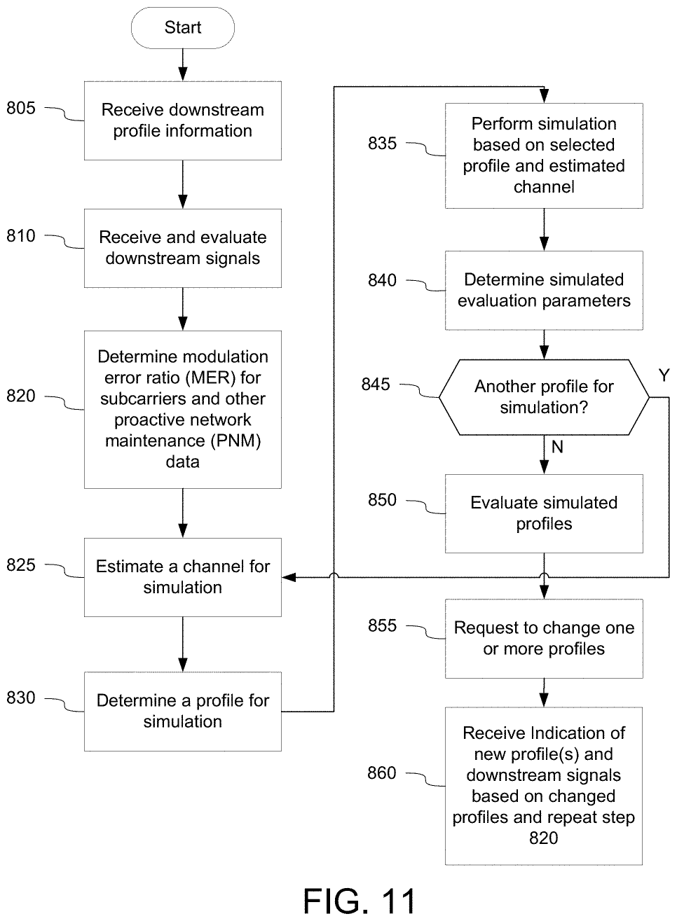

FIG. 11 is a flow chart showing an example method for evaluating one or more modulation profiles. A user device (e.g., the user device 500 or the user device 600) may perform the operations shown in FIG. 11. Some or all steps shown in FIG. 11 may also or alternatively be performed by one or more other computing devices (e.g., the termination system 305, a server communicating with the user device and/or with a termination system, etc.). One or more steps may be added, omitted, and/or rearranged. In step 805, the user device may receive downstream profile information. For example, a termination system (e.g., the termination system 305) may send, to the user device, information indicating that the termination system will use 256 QAM, 1024 QAM, and 4096 QAM in generating downstream signals to be sent to the user device. In step 810, the user device may receive the downstream signals and evaluate the downstream signals. For example, the user device may select one or more channels and/or one or more subcarriers for evaluation. Different profiles may be used for each subcarrier and/or for each channel. For each subcarrier and/or for each channel, the user device may analyze one or more profiles.

In step 820, the user device may determine MER for each subcarrier (and/or each channel) and may determine other evaluation parameters and PNM data. For example, the user device may determine RxMER for each subcarrier, AWGN, and other simulation configuration parameters to determine the current channel estimate. In step 825, the user device may estimate a channel for simulation. In step 830, the user device may determine one or more profiles for simulation. In step 835, the user device may perform, based on the selected profile(s) and the estimated channel, a simulation. For example, the user device may select one profile at a time and perform a simulation for the selected profile in a single simulation iteration (e.g., one iteration of operation from the profile selector 701 to the profile evaluator 713 shown in FIG. 9). After completing a single simulation iteration, another profile may be selected for the next simulation iteration. The user device may select a plurality of profiles and simulate the selected plurality of profiles at the same time during a single simulation operation. For example, in a single simulation operation, the user device may select 2048 QAM and 4096 QAM and modulate a test code using the selected 2048 QAM and 4096 QAM. The simulation may provide simulation results for evaluating both the 2048 QAM and 4096 QAM.

In step 840, the user device may determine simulated evaluation parameters. For example, the user device may determine the simulated BER, the simulated LDPC statistics, and the simulated BCH statistics described above. In step 845, the user device may determine whether another profile for simulation exists. If yes, the user device may repeat step 825. If no, the user device may perform step 850. In step 850, the user device may evaluate simulated profiles. The evaluation may comprise an analysis of the simulated evaluation parameters and the actual evaluation parameters from steps 810 and/or 820. In step 855, the user device may send, to the termination system, a request to change one or more profiles. For example, the user device may send a report comprising the evaluation of the simulated profiles and a recommendation about one or more profiles. In step 860, the user device may receive, from the termination system, an indication of one or more new profiles selected for the user device, and the user device may receive downstream signals generated based on one or more new profiles selected by the termination system. In step 860, the user device may repeat step 820 to evaluate one or more profiles (e.g., the one or more new profiles).

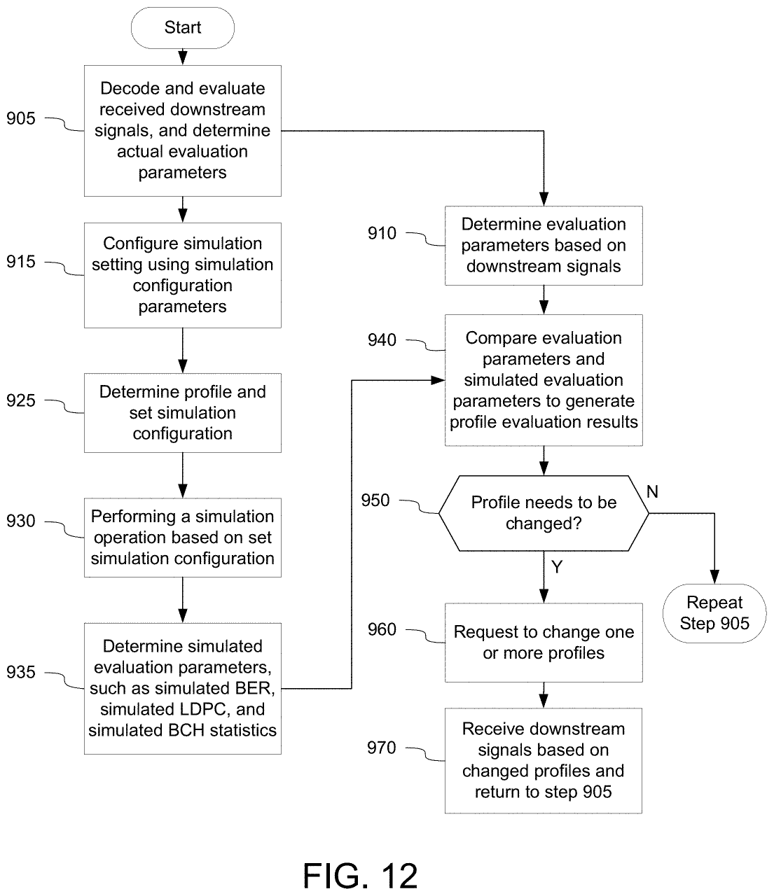

FIG. 12 is a flow chart showing an example method for evaluating one or more profiles based on one or more simulated evaluation parameters. A user device (e.g., the user device 500 or the user device 600) may perform the operations shown in FIG. 12. Some or all steps shown in FIG. 12 may also or alternatively be performed by one or more other computing devices (e.g., the termination system 305, a server communicating with the user device and/or with a termination system, etc.). One or more steps may be added, omitted, and/or rearranged. In step 905, the user device may decode and evaluate downstream signals. In step 910, the user device may determine, based on an analysis of the downstream signals, actual evaluation parameters. The actual evaluation parameters may comprise parameters for configuring a simulation setting, such as MER and AWGN. For example, the MER and AWGN may be used to determine an estimated channel to be used for a simulation operation. In step 915, the user device may configure a simulation setting using the simulation configuration parameters. In step 925, the user device may determine one or more profiles for simulation and may set a simulation configuration. In step 930, the user device may perform, based on the set simulation configuration, a simulation operation.

In step 935, the user device may determine, based on performing the simulation operation, simulated evaluation parameters, such as simulated BER, simulated LDPC statistics, and simulated BCH statistics. In step 940, the user device may compare the actual evaluation parameters from step 905 with the simulated evaluation parameters to generate profile evaluation results. In step 950, the user device may determine whether one or more simulated profiles should be modified or replaced in generating future downstream signals. If no, the user device may repeat step 905. If yes, the user device may perform step 960. In step 960, the user device may send, to the termination system, a request to modify or replace the one or more simulated profiles. In step 970, the user device may receive downstream signals generated based on one or more changed profiles. In step 970, the user device may return to step 905.

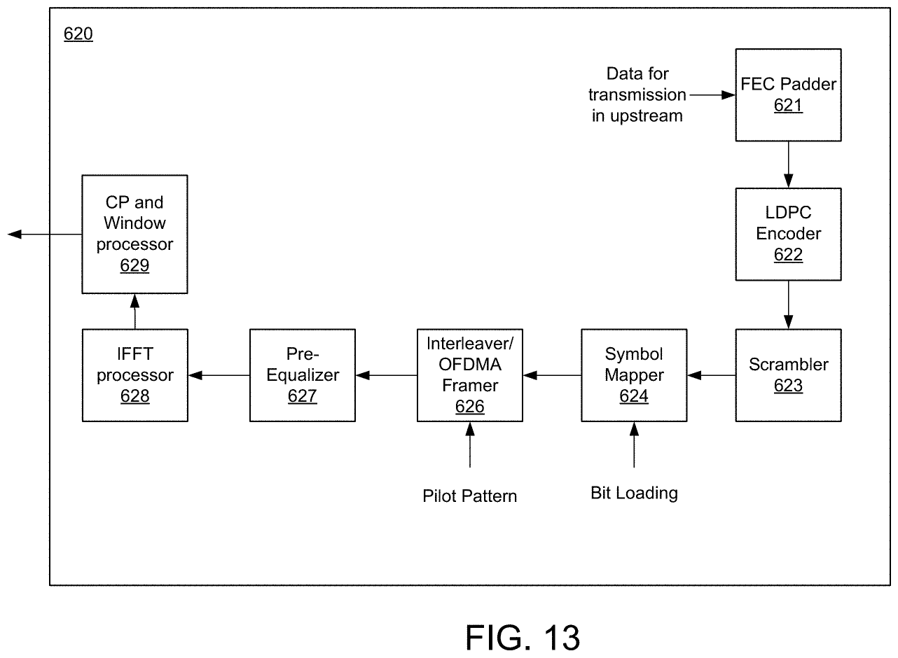

FIG. 13 shows an example of components comprised by the upstream signal processor 620 of FIG. 7. The upstream signal processor 620 may generate an upstream signal using an orthogonal frequency-division multiple access (OFDMA) modulation scheme. A user device (e.g., the user device 600 or other user devices) may generate upstream signals using OFDMA frames. Each OFDMA frame may be comprised of a configurable number of OFDM symbols. A plurality of transmitters may share the same OFDMA frame by transmitting data and pilots on allocated subcarriers of the OFDMA frame. The user device may be allocated to transmit one or more groups of subcarriers in a transmission burst signal. The upstream signal processor 620 of the user device may comprise an FEC padder 621, an LDPC encoder 622, a scrambler 623, a symbol mapper 624, an interleaver/OFDMA framer 626, a pre-equalizer 627, an IFFT processor 628, and a CP and window processor 629. The upstream signal processor 620 may generate the transmission burst signal. Data bits may be determined for a transmission in an upstream signal. The FEC padder 621 may receive the data bits and may pad the data bits with FEC padding bits. The LDPC encoder 622 may receive the data bits padded with the FEC padding bits and may encode using an LDPC encoding algorithm. The LDPC-encoded signal may comprise a plurality of LDPC codes (e.g., long, medium, and short FEC codes). The scrambler 623 may scramble the encoded bits using a scrambler (e.g., a PRBS scrambler). The scrambler 623 may output scrambled bits that may be converted into constellation symbols. The symbol mapper 624 may convert the scrambled bits into the constellation symbols. Subcarriers may have different types, such as pilots, complementary pilots, and data subcarriers. The conversion into the constellation symbols may be performed according to a corresponding bit loading scheme.

The interleaver/OFDMA framer 626 may put the constellation symbols into an OFDMA framer and an interleaver block. The OFDMA framer may add pilots according to a corresponding pilot pattern of the transmission burst signal. The constellation symbols may be interleaved in time and frequency. The pre-equalizer 627 may receive the output of the interleaver/OFDMA framer 626 and may apply pre-equalization in order to pre-distort the upstream signals. The pre-equalization may be performed based on coefficients received from a termination system (e.g., the termination system 305) to compensate for the channel response. The IFFT processor 628 may transform the pre-equalized symbols into a time domain signal using an IFFT block. The CP and window processor 629 may receive the output of the IFFT processor 628 and may add, to the output of the IFFT processor 628, a cyclic prefix and window in the time domain.

A termination system (e.g., the termination system 305) may comprise a profile simulator similar to the profile simulator 215 of the user device 600. For example, the profile analyzer 420 may comprise a profile simulator to simulate the received upstream signals. One or more portions of the profile simulator of the termination system may or may not be identical to the profile simulator 215 The OFDMA signal generation by the upstream signal processor 620 may be different from the OFDM signal generation by the signal processor 430 (e.g., a downstream signal processor) of the termination system 305. However, various examples described herein may be applied to the profile simulation of the received upstream signals. The profile simulator of the termination system may replicate an upstream OFDMA signal for simulation and simulate the replicated upstream OFDMA signal. Various simulated evaluation parameters, such as the simulated BER and the simulated LDPC statistics, may be obtained.

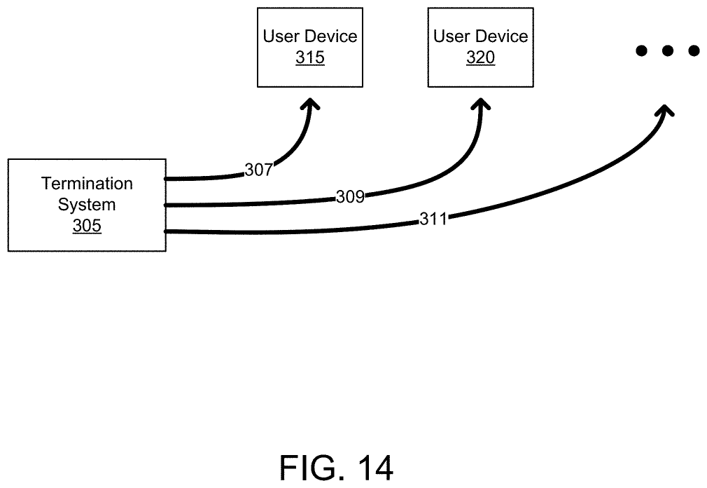

FIG. 14 shows an example of a termination system 305 providing multiple modulation profiles to user devices 315 and 320. For example, the termination system 305 may provide a first modulation profile 307 to the user device 315 and a second modulation profile 309 to the user device 320. The first modulation profile 307 and the second modulation profile 309 may comprise the same modulation profile or different modulation profiles. The termination system 305 may send the same modulation profile to two (or more) user device, or different modulation profiles to different user devices. The termination system 305 may similarly provide modulation profiles, such as the modulation profile 311, to other user devices (not shown).

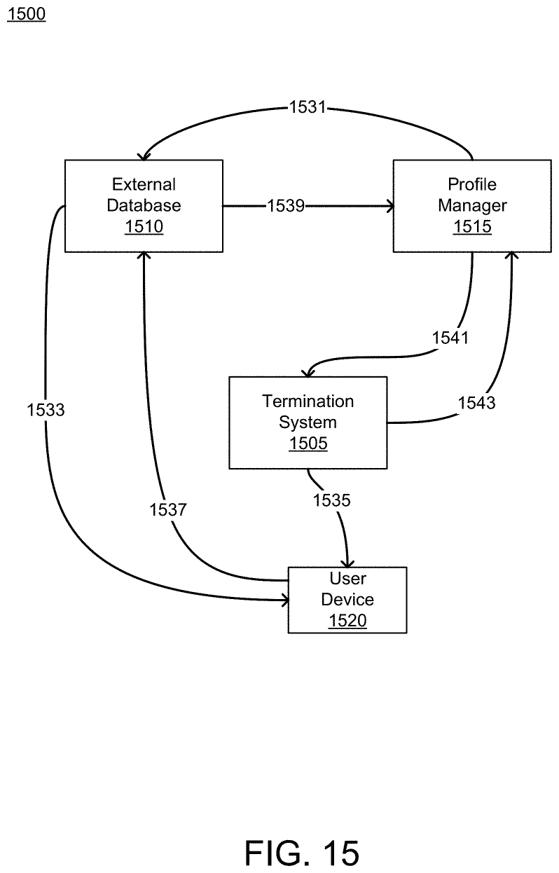

FIG. 15 shows an example network of devices 1500 used to provide one or more modulation profiles to user devices. The network 1500 may comprise a termination system (TS) 1505 (e.g., the TS 104, the TS 305, etc.). The network 1500 may also comprise an external database 1510 configured to receive various parameters from the termination system 1505. The database 1510 may comprise, for example, a Simple Network Management Protocol (SNMP) manager.

The network 1500 may comprise a profile manager 1515 (e.g., a computing device) configured to query the database 1510 and to process information, received from the database 1510, by applying, for example, technical and/or business rules to determine one or more modulation profiles, such as optimal modulation profiles, to be used by each user device 1520 (e.g., the user device 500, the user device 600, one or more user devices of the user device groups 315, 320, 325, and 330, etc.). The information received from the database 1510 may comprise one or more actual evaluation parameters, one or more simulated parameters, and/or evaluation reports reported by the user device 1520. The profile manager 1515 may instruct the termination system 1505 how to implement the various profiles for each user device or for each service group. The profile manager 1515 may query the database 1510 and process the information to determine which user device within each service group will be assigned to each modulation profile.

The external database 1510 and the profile manager 1515 may be in the same system or computing device (e.g., server) or may be configured in separate computing devices. The external database 1510 and the profile manager 1515 may be external to the termination system 1505. The external database 1510 and the profile manager 1515 may be part of the termination system 1505.

The profile manager 1515 may send, to the external database 1510, an instruction message 1531 to initiate a measurement of signal quality at one or more user devices 1520. The instruction message 1531 may be generated, for example, if a request from the termination system 1505, the user device 1520, or the external database 1510 is received. The instruction message 1515 may be sent periodically (e.g., three times per day, every hour, every ten minutes, etc.) or may be sent on an on-demand basis. Signal quality may be measured by an MER, an SNR, coding analysis, bit error ratio (e.g., for optical fiber communications), and/or other value(s). The measurements may comprise downstream or upstream measurements by one or more user devices (e.g., the user device 1520). The measurements may be performed for one, some, or all modulation carrier signals, including OFDM subcarriers. Measurements of the carriers or subcarriers may be used to identify, for example, noise and interference on a communication line or at the user device 1520. The signal quality measurements may be used to optimize the carriers and subcarriers.

The external database 1510 may send an instruction message 1533 or may cause the termination system 1505 to initiate a test on each user device 1520, such as the CmDsOfdmRxMer test specified in the DOCSIS 3.1 standard. The CmDsOfdmRxMer test may instruct the user device 1520 to perform a MER test on a received downstream OFDM signal. The external database 1510 may initiate the test via, for example, Simple Network Management Protocol (SNMP) sets or any other network management protocol.

The termination system 1505 may send a message 1535 that instructs the user device 1520 to measure a communication signal quality. The user device 1520 may measure its signal quality, such as its downstream MER on each subcarrier. The user device 1520 may perform the measurement by examining scattered pilots and/or PHY Link Channel (PLC) preamble symbols.

The user device 1520 may report a message 1537 comprising the measurement results to the external database 1510 via, for example, a file upload, such as a Trivial File Transfer Protocol (TFTP) file upload. The user device 1520 may generate a results file with its test results and send the file to the external database 1510, such as via TFTP.

The external database 1510 may provide a message 1539 comprising one or more of test results or instructions to the profile manager 1515 via a network communication protocol. The profile manager 1515 may analyze the data of the rest results to identify wireless signal ingress, whether the MER is within a certain range, whether the modulation for a particular user device 1520 is to be changed based on the test results, and/or to generate other evaluation results. The user device 1520 may analyze its own test results and send the analyzed test result data to the external database 1510 and/or the profile manager 1515 (e.g., instead of or in addition to the profile manager 1515 analyzing raw data from the user device 1520).

The profile manager 1515 may determine (e.g., create) a new modulation profile, such as a downstream profile or an upstream profile, and assign one or more user device candidates to the new profile on the termination system 1505. The profile manager 1515 may send, to the termination system 1505, a message 1541 indicating the new modulation profile. For example, the profile manager 1515 may increase or decrease the order of modulation (which may be in bits per second per hertz). Exemplary modulation orders include, but are not limited to, BPSK, QPSK, 16 QAM, 64 QAM, 256 QAM, 512 QAM, 1024 QAM, 2048 QAM, 4096 QAM, 8K QAM, 16K QAM, etc. The profile manager 1515 may update a user device's modulation profile in response to, for example, the signal quality (e.g., MER or SNR) falling below a threshold quality.

The assignment may be via a control interface, such as an internet protocol control interface (e.g., common open policy service (COPS) or any other internet protocol). The control interface may comprise a web services interface, such as a Representational State Transfer (REST) interface, including a RESTful interface. The modulation profile may specify an adjustment to the physical layer used by a cable modem to communicate with other devices, such as the termination system 1505. The modulation order for each subcarrier, modulation scheme, coding scheme, data speed, or any other factors may be adjusted for the cable modem. Some zones may be blocked altogether in profile definitions. User devices may be placed in different service groups based on the new modulation profile selected by the profile manager 1515.

The termination system 1505 may initiate a test of the new profile on each user device candidate, such as via a standard DOCSIS-defined mechanism. The termination system 1505 may move the user device to a new modulation profile if the test for that user device was successful. The termination system 1505 may send, to the profile manager 1515, a message that acknowledges the new profile creation and user device profile assignment changes to the profile manager 1515, via a protocol such as COPS or REST.

Modulation profiles may be updated to reduce one or more impacts of wireless ingress, such as LTE wireless ingress. Major wireless voice/data carriers may provide LTE service using various frequency bands in the over-the-air RF spectrum. One LTE band commonly used in the U.S. (that may have a significant impact on cable systems) is referred to as the 700 MHz band (e.g., 698-806 MHz). If a coaxial cable in the cable operator's outside plant has damage to the cable's shielding, there may be a potential for over-the-air signals in the 700 MHz band to enter the cable and directly interfere with cable system DOCSIS channels operating at this frequency. This type of interference may be referred to as ingress.

The impact of ingress on the DOCSIS signals can be measured via a reduction in the MER of the DOCSIS channels. The data carrying capacity of a DOCSIS 3.1 channel may be directly affected by the MER value. With a higher MER value, a more complex signal modulation scheme can be used to carry more data in a given amount of spectrum. Conversely, with a lower MER value, a less complex signal modulation scheme may be used, which might carry less data in a given amount of spectrum.

700 MHz LTE ingress may occur in less than all DOCSIS segments (e.g., less than all areas of an outside plant). Accordingly, one or more computing devices of the system described herein may be selectively used to protect the DOCSIS network from LTE ingress where the LTE ingress occurs and may be omitted where such ingress does not occur). Because implementing an LTE ingress protection scheme may have the side-effect of lessoning the data carrying capability of a DOCSIS channel in a spectral region, limiting use of the LTE ingress protection to portions (spectral regions) experiencing LTE ingress may allow prevention of unnecessary reduction of data carrying capability.

The modulation profile management system described herein may measure MER on one or more (e.g., all) sub-carriers that make up the DOCSIS 3.1 channels on each network segment. A system comprising one or more computing devices (e.g., the external database 1510, the profile manager 1515, the termination system 1505, etc.) and one or more user devices (e.g., the user device 1520) may be programmed with specific algorithms to inspect the MER measurements and identify network segments where ingress is occurring. For example, the system may look for abnormally reduced MER measurements in the 700 MHz band. If the system identifies network segments showing low MER values in this band, the system may reconfigure the network to prevent data loss at the physical layer of the DOCSIS network, which might otherwise occur.

For example, if most of the DOCSIS 3.1 channel subcarriers are normally configured to make use of 4096 QAM modulation, the system may examine the MER values in the 700 MHz band and determine what QAM modulation order is a best fit for the network conditions in this band. The system may reduce the modulation order on the affected subcarriers to a value that may reduce a data error rate of communication through the impacted band (e.g., 1024 QAM or 256 QAM, instead of 4096 QAM).

Although reduction in modulation order on the subcarriers in this band may slightly reduce the efficiency of a given DOCSIS 3.1 channel, a slight reduction may be preferred to the alternative—inducing code word errors on the channel and potentially causing a loss of user data on the network. Reduction in modulation order in this band may slightly reduce the efficiency of the specific DOCSIS network segment, but other network segments (e.g., segments without signs of LTE ingress) may be left configured to use the more efficient 4096 QAM on the subcarriers of the 700 MHz band, thus maximizing their efficiency.

One or more profiles for one or more user devices may be selected based on geographical location associated with the one or more user devices. For example, modulation in one neighborhood (e.g., with little measurable ingress) may be set to 4096 QAM, and modulation in another neighborhood may be set to 1024 QAM. As another example, locations closer to the termination system 1505 may be assigned to higher-order modulation, whereas locations farther from the termination system 1505 (yet still served by the termination system 1505) may be assigned to lower-order modulation.

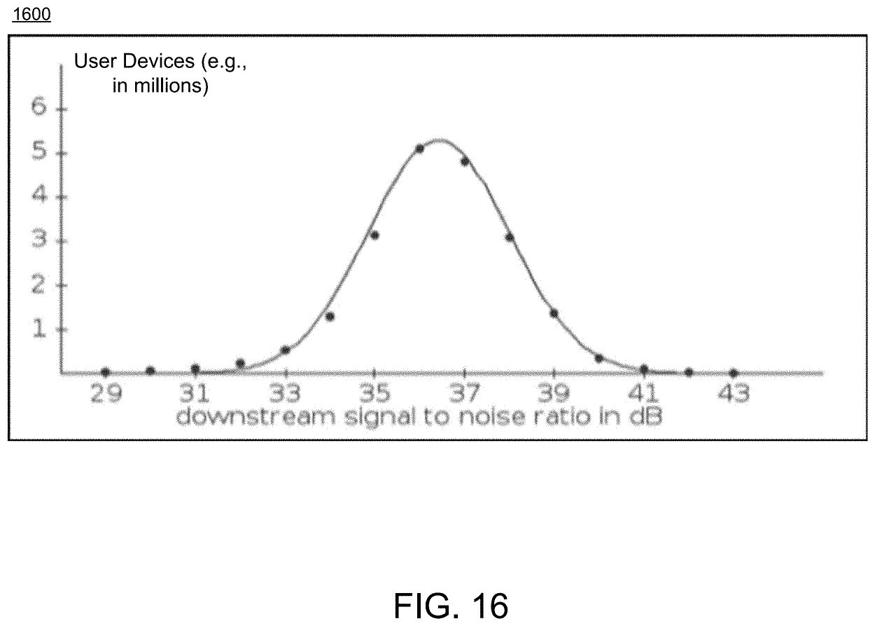

One or more updates and/or updating processes of modulation profiles may be used to optimize channel capacity based on hybrid fiber-coaxial (HFC) plant variation. Within a network segment (e.g., service group), cable modems may have varying levels of receiver MER with a distribution that closely matches a distribution, such as a Gaussian distribution. FIG. 16 shows an example distribution 1600 signal to noise ratio at user devices that may be used to determine one or more modulation profiles for each user device.

The varying levels of receiver MER with a distribution that closely matches a distribution, such as a Gaussian distribution, may be used to maximize channel capacity by instructing the modulation profile manager 1515 to assign each modem into the highest modulation order profile based on its MER. Assume, for example, that 4 uniform bit-loaded profiles are created: A, B, C and D with modulation order of 256 QAM, 1024 QAM, 2048 QAM and 4096 QAM, respectively. The modulation profile manager 1515 may perform channel optimization by periodically initiating the MER measurement in each service group (e.g., by sending the instruction message 1531 described with reference to FIG. 15). Using results of the measurement process (e.g., based on results obtained via one or more of the messages 1533-1539), each modem's MER may be compared against the thresholds for each profile, and the modem may be assigned to the highest order profile that matches. As shown in FIG. 16, if the sample size of the user device is large enough, the downstream SNR statistics associated with user devices may show a pattern close to a Gaussian distribution. A large number of user devices may have SNR value of 36 dB. FIG. 16 shows that the mean of the downstream SNR values may be about 36.5 dB, and the median of the downstream SNR values may be about 36 dB. Cable modems having a higher downstream SNR value (e.g., 40 dB) may have a good channel quality and may use a high modulation order (e.g., 4096 QAM) without experiencing a high data error rate of communication. Cable modems having a lower downstream SNR value (e.g., 33 dB) may be in a noisy channel environment that may cause a high data error rate of communication if a high modulation order is used. For example, and with reference to FIG. 16, if cable modem 1 had an MER of 40 dB (e.g., a higher SNR or MER), the highest modulation order that it might be placed into may be 2048 QAM or 4096 QAM. The manager 1515 may assign it into Profile C or Profile D. If cable modem 2 in the same service group had a MER of 36 dB (e.g., a medium-level SNR or MER), it may be assigned to Profile B because at most 1024 QAM is the highest QAM order cable modem 2 may be able to support. If cable modem 3 had a MER of 33 dB (e.g., a low-level SNR or MER), it may be assigned to Profile A (e.g., 256 QAM). This process of assigning each modem into the highest profile may be done for some or all modems, thereby maximizing the channel capacity. Based on the SNR distribution statistics, different profiles may be efficiently allocated to different user devices. An optimized allocation scenario may be obtained by finding out a profile allocation that maximizes the channel capacity.

The process may repeat one or more times, on a regular or irregular basis, over any duration as the MER values slowly vary as a function of changing environmental conditions, aging effects of components in the HFC plant, local activity of in-home appliances, etc. The modulation profile manager 1515 may assign to cable modems either a higher or lower capacity profile based on the MER change.

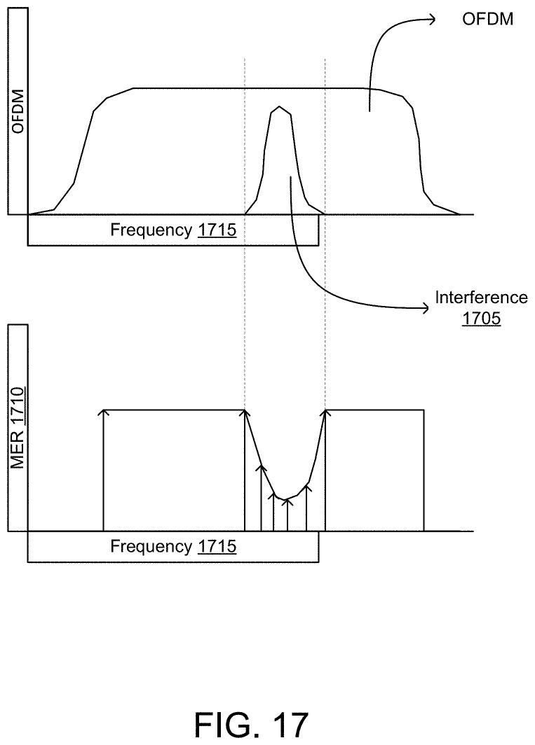

FIG. 17 shows an example of signal ingress and its effect on error ratio. Interference 1705 (e.g., signal ingress, such as LTE signal ingress) may lower the MER 1710 for one or more frequencies or frequency bands 1715. As will be described in further detail below, one of more computing devices of the system (e.g., the external database 1510, the profile manager 1515, the termination system 1505, etc.) may lower the modulation order for devices using certain subcarriers affected by signal ingress. User devices may measure their downstream and/or upstream signal qualities (e.g., MERs) and send the measurements to a termination system or other network device.

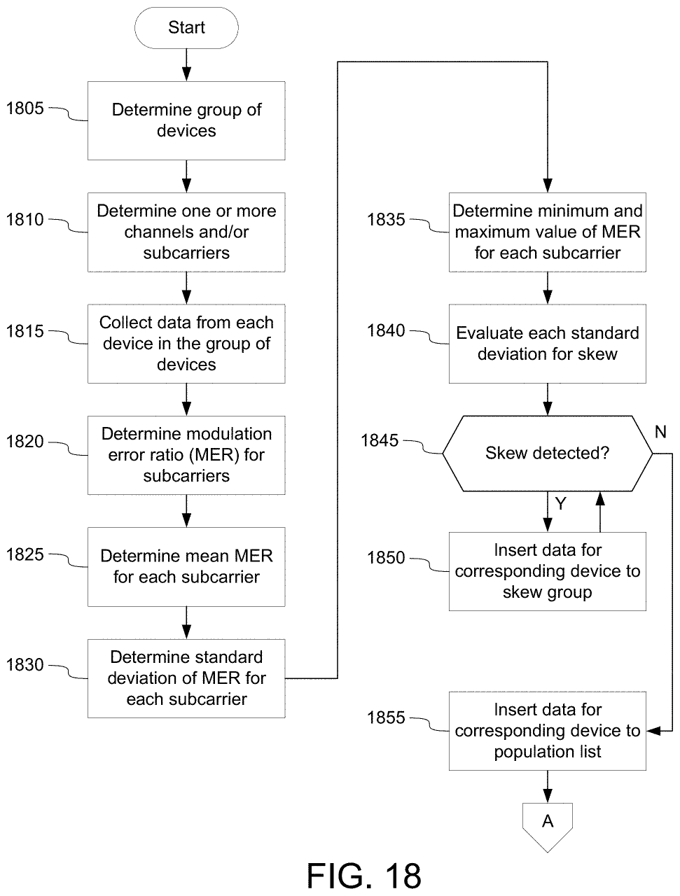

FIG. 18 shows at least a portion of a method for determining one or more data modulation profiles for groups of devices. One or more computing devices of the system (e.g., the external database 1510, the profile manager 1515, the termination system 1505, etc.) may evaluate each device of a certain downstream group. Some or all steps shown in FIG. 18 may also be performed or alternatively be performed by one or more other computing devices (e.g., the termination system 305, a server communicating with the user device and/or with a termination system, etc.) One or more computing devices of the system may perform a standard deviation function for each subcarrier error rate (e.g., MER). For example, one or more computing devices of the system may determine a standard deviation of each subcarrier error rate for a subcarrier across each device in a group of n devices. The function may comprise Stdev(device-1-SC-1, device-2-SC-1 . . . device-n-SC-1). One or more computing devices of the system may determine the average MER and/or the spread of the MER. The standard deviation may be found for each of the subcarriers, until each subcarrier is evaluated. One or more computing devices of the system may generate N profiles of different robustness depending on, for example, the MER data and the standard deviation calculations.

With reference to FIG. 18, in step 1805, a computing device may determine a group of user devices to evaluate, such as a device (e.g., modem) population. The devices in a single group may be devices in a particular geographic area and/or devices in communication with the same node (e.g., a termination system, a base station, an access point, etc.).

In step 1810, the computing device may determine one or more channels and/or subcarriers of the channels to evaluate. For example, the computing device may determine an OFDM channel for transmitting data to and/or receiving data from the devices in the group (e.g., from and/or to an upstream node). The computing device may similarly determine the subcarriers in the channel. The OFDM channel may have N number of subcarriers. As will be described below, each subcarrier may be evaluated against each device in the device (e.g., modem) population.

In step 1815, the computing device may collect data from each device in the selected group of devices. The collected data may comprise MER (e.g., RxMER), SNR, or any other data indicative of error rate. MER may be used as a proxy for the SNR. The collected data may also comprise, for example, FEC data. Devices may encode messages in a redundant way using a code (e.g., error-correcting code), which can be compared to the body of the message to detect errors. The data collected by the computing device may comprise PNM data. The computing device might collect data, for example, 8 or 9 symbol times (or any other number of times) if the data collected is over a short duration. The computing device may collect multiple captures over time. This could be any number, such as N+1. A faster sample time may be used in order to detect burst noise, which may be shorter than 8 symbols in length.

The computing device may collect enough data to generate an MER for each point (e.g., for each subcarrier). Measurement data may be collected from each device in a downstream serving group. The collected data may comprise one or more signals coming via an S connector of a termination system (e.g., a CMTS), and each S connector may be going out to a particular area in the modem population world.

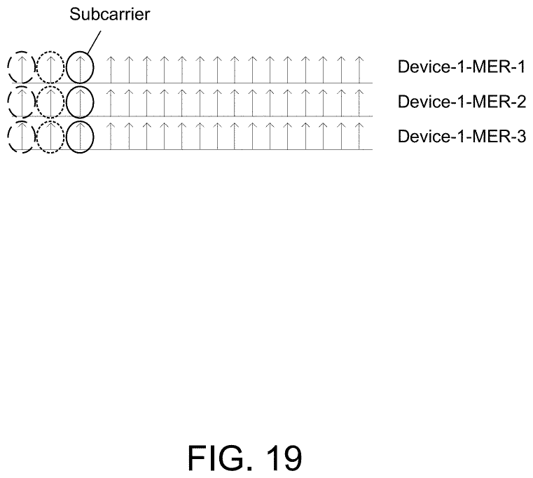

FIG. 19 shows examples of a plurality of subcarriers for one or more devices. The N+1 data collection described above may be received from a device, such as device 1. As shown in FIG. 19, the computing device may collect sample data (e.g., device 1-MER-1, device 1-MER-2, device 1-MER-3, and so forth). Each arrow may comprise a subcarrier.

Returning to FIG. 18, in step 1820, the computing device may determine the MER for the subcarriers from the data collected in step 1815. In step 1825, the computing device may determine the mean (e.g., average) of MER values for each subcarrier, such as the average of the N+1 data samples. The computing device may calculate the average decibel (dB) value for each of the subcarriers. For example, if the first MER is 50, the second MER is 50, and the third MER is 50, the computing device may calculate the average MER as 50 dB. The mean MER may be closer to, for example, 41 dB. As will be described below, the computing device may normalize the average MER of a particular profile over a period of time.

In step 1830, the computing device may determine the standard deviation of the MER for each subcarrier. For example, the first deviation may be 0.5 dB or 1 dB from the mean of the MER. The function used for a first subcarrier (SC-1) may be represented as stdev(MER @SC-1). The computing device may calculate a standard deviation for each user device's MER average. A spread, which may be measured by the standard deviation, may be used to determine how many modulation profiles to assign.

In step 1835, the computing device may determine a minimum and/or a maximum value of the MER for each subcarrier. The computing device may determine the lowest MER across a device population per subcarrier (e.g., floor(MER[ ])) and/or the highest (or best) MER across a device population per subcarrier (e.g., ceiling(MER[ ])).

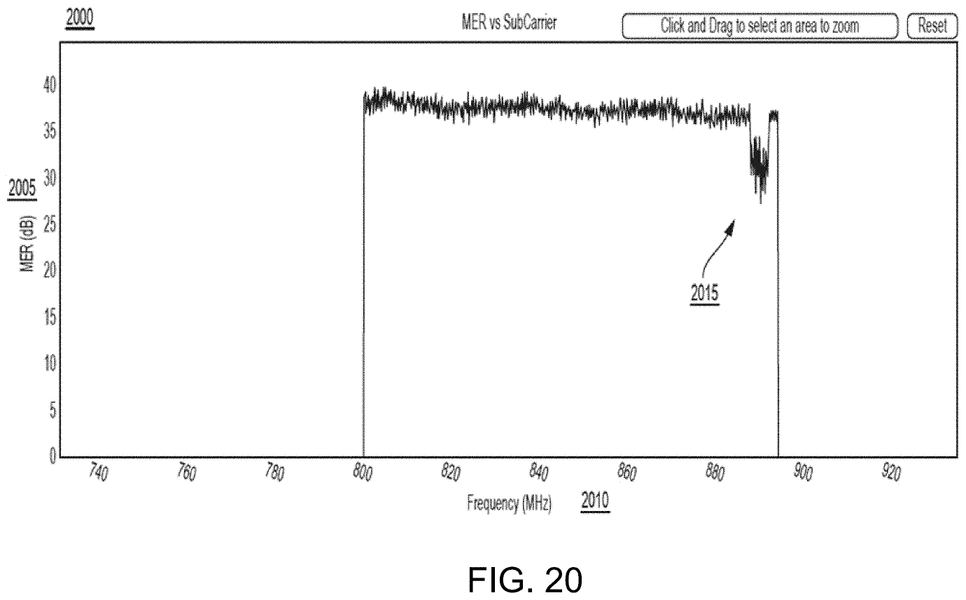

In step 1840, the computing device may evaluate each standard deviation for skew (e.g., asymmetry in a statistical distribution). FIG. 20 shows an example 2000 of detecting skew for determining signal ingress. A PNM (or other) application may plot the MER magnitude in dB 2005 versus subcarrier frequency 2010 in a graphical format. Variations in MER may be due to variation in the receive level, the ingress strength among the subcarriers, or a combination of both. In displaying the MER (e.g., RxMER), ingress or network impairments may be graphically viewed. As shown in FIG. 20, a search criterion may be used to search for devices with a standard deviation greater than one, with a skewness value less than a threshold (e.g., −1) to detect sharp ingress. The dip 2015 shown in the graph may be caused by LTE or 3G signal ingress in one or more carriers and may be used to determine if there is a wireless signal ingress (e.g., 3G, 4G LTE, and/or 5G signal ingress). It might be unknown how the signal ingress was introduced, but the standard deviation and skewness may be used as key performance indicators (KPIs). Using automation, devices, such as cable modems, can be quickly screened for a potential problem.

The computing device may determine whether the skewness satisfies (e.g., is greater than) a threshold (e.g., less than minus 1). If so, the skewed data may be removed. If not (e.g., skewness between 0 and minus 1), the computing device may determine that the data is not skewed and keep the data for the device in the population group.

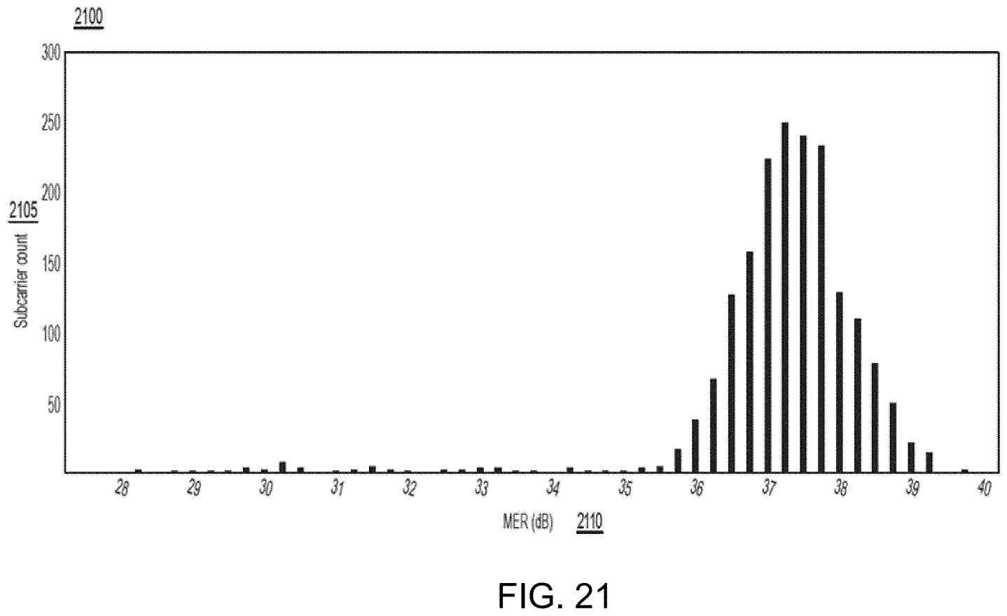

FIG. 21 shows an example of detecting skew for determining signal ingress. In particular, FIG. 21 shows a distribution of subcarrier count per MER (e.g., the number of subcarriers at each MER). Skewness is observed with a shift of the MER count to the right.

Returning to FIG. 18, in step 1845, the computing device may determine whether skew was detected for any of the devices. If there are skews in the data, the skews may cause an issue with grouping devices. Skews in the data may indicate that the data does not properly distribute evenly. The skews may be caused by a signal ingress. The process for identifying skewness may be similar to a noise cancellation process. For example, instead of using a FFT or digital processing, the computing device may perform instant polarization and find the slope, for example, equivalent to 3 dB cut off on each end. The computing device may determine the frequencies corresponding to the slope, and create a cancellation. A moving average may be used to determine where a slope caused by signal ingress begins and ends, and the computing device may exclude data (e.g., frequencies) between those two slopes for the present population. Additionally or alternatively, a Gaussian distribution analysis of the data may be performed. If the computing device finds a skewness value of less than a threshold (e.g., less than minus 1), the computing device may determine that that is a key performance indicator and that there is a sharp ingress in the OFDM channel.

If skew was detected (step 1845: Y), in step 1850, the computing device may insert the data for the corresponding device in a different group, such as its own group or a group of devices having skewed data. For cable modems, the computing device may insert the CM RxMER PNM data into a CM skewness list/group. If skewness caused by signal ingress is identified, the corresponding device may be excluded from the device population list, and the device may be addressed separately (or with other skewed devices). An exclusion area may be created to exclude certain subcarriers. Removing skewness may be performed in order to maintain an even distribution of data.

A separate modulation profile may be created for devices having skewed data (e.g., profile E). A termination system may support eight or more different profiles. One or more of those profiles may be assigned to devices without skewed data, and one or more profiles may be assigned to devices with skewed data. A device, such as a cable modem, may support multiple profiles (e.g., up to or more than four different profiles).

If skew was not detected (step 1845: N), in step 1855, the computing device may insert the data for the corresponding device into a population list. For cable modems, the computing device may insert CM RxMER PNM data into a CM SG Population List (SGPL). The list may comprise an indexable array of MER data that may be identified by cable modem IDs (e.g., addresses).

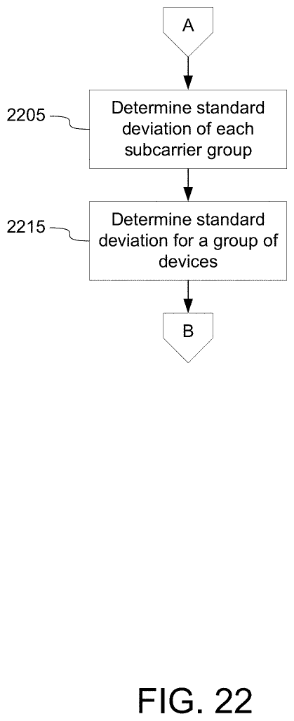

FIG. 22 shows at least a portion of a method for determining one or more data modulation profiles for groups of devices. The method may be performed by one or more computing devices of the system (e.g., the external database 1510, the profile manager 1515, the termination system 1505, etc.), but some or all steps could be performed by one or more other computing devices. For example, one or more of the external database 1510, the profile manager 1515, the termination system 1505, and/or the user device 1520 may perform one or more different steps of the method. As a result of one or more of the steps shown in FIG. 18, one or more computing devices of the system may have individual MER data for each point of a particular OFDM channel across, for example, N+1 devices. After collecting the individual MER data, one or more computing devices of the system may create a standard deviation for each user device's MER average of each subcarrier group.

In step 2205, a computing device may determine the standard deviation for each user device's MER average of each subcarrier group. For example, the computing device may evaluate each subcarrier in a group individually, and apply a standard deviation algorithm. A group of subcarriers may be used in a particular channel, such as an OFDM channel.

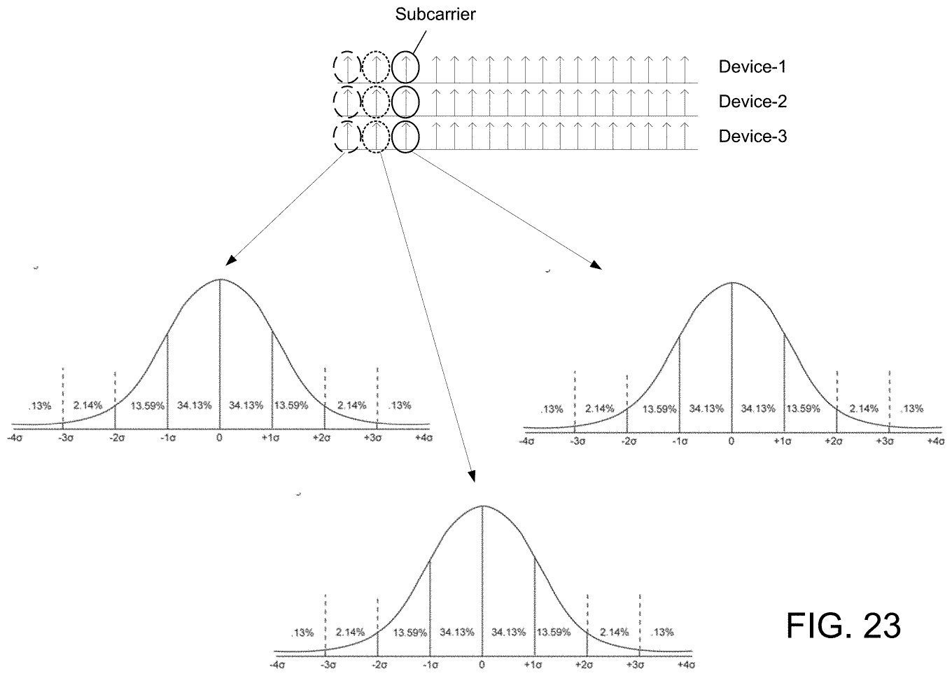

FIG. 23 shows an example of determining one or more standard deviations for one or more subcarriers. FIG. 23 shows 18 subcarriers, but there may be any number of subcarriers, such as 1800 subcarriers, 4000 subcarriers, etc. The subcarriers may be part of the same channel, such as an OFDM channel. For the sake of brevity, FIG. 23 shows 3 devices (device 1, device 2, and device 3) being evaluated, but any number of devices in the network may be evaluated. The devices may be in the same group, such as a serving group.

For example, 3 devices at 3 different parts of the network may be using the same OFDM channel for communication. Each row of subcarriers may represent a single OFDM channel. The number of subcarriers may be represented by the number of arrows. The devices may be geographically close to each other or geographically far from each other. For example, device 1 could be 3 miles from device 2, and device 3 could be 10 miles from device 1. However, the devices may be in the same group of devices (e.g., a serving group) and may be fed from the same communication line(s) and/or networks (e.g., from the same cable for cable modems). The computing device may compute the mean and standard deviation for one of the subcarriers. Assume that the subcarrier MER for device 1 is 40, the subcarrier MER for device 2 is 42, and the subcarrier MER for device 3 is 39. Based on these three data points, the computing device may determine that the mean is 40.33 and the deviation is approximately 1. Although this example relies on 3 data points, many more data points (e.g., hundreds, thousands, tens of thousands, etc.) may be included in the calculation because groups of devices may comprise hundreds, thousands, or tens of thousands of devices. As described herein, the standard deviation for a group of devices may be used to determine whether to group the devices together for data distribution via one or more channels and/or subcarriers.

The computing device may determine one or more devices for a simulation based on the mean of each user device's MER and the standard deviation for each user device's MER average. For example, the computing device may determine one or more devices for which the subcarrier MER is lower than a threshold MER. The threshold MER may be determined by adding an offset value to the mean MER. The computing device may perform a simulation to determine a possible profile change for the one or more devices using the standard deviation and/or the mean as an evaluation parameter. The computing device may cause the one or more devices to perform a simulation of a profile using the standard deviation and/or the mean as an evaluation parameter. For example, the profile simulator 215 may determine one or more profiles that comprise one or more subcarriers that cause the standard deviation to be above the threshold deviation, and may simulate the determined one or more profiles using one or more simulation methods described herein. The profile simulator 215 may use other evaluation parameters to calibrate simulation settings and/or to generate additional profile analysis results. Returning to FIG. 22, in step 2215, the computing device may determine the standard deviation for each user device's MER average for a group of devices (e.g., a serving group) after the computing device determines the standard deviation of each subcarrier group (e.g., in step 2205).

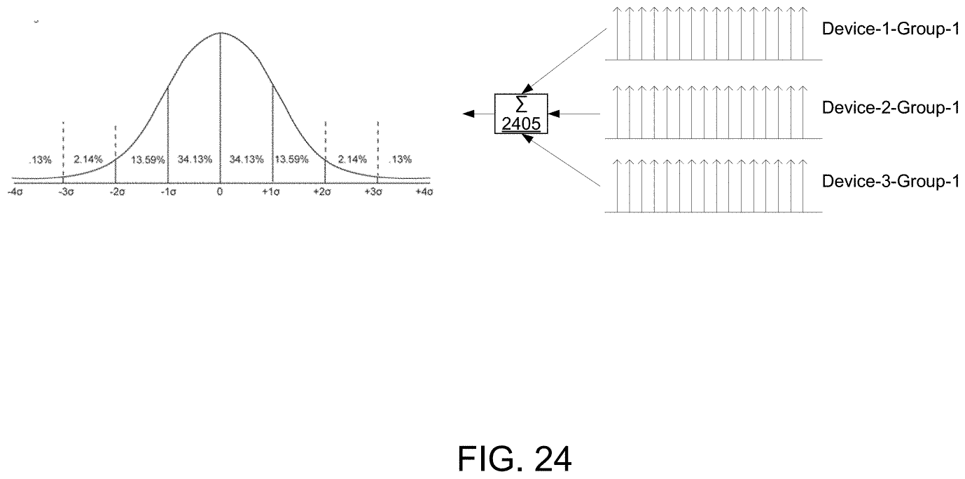

FIG. 24 shows an example of determining one or more standard deviations for each user device's MER for one or more devices in a group. With respect to the right side of FIG. 24, each row may represent a device in the group (e.g., a cable modem in a particular serving group). The computing device may take the data from a group that is not skewed. FIG. 24 shows 3 devices in group 1, but group 1 may include hundreds, thousands, or tens of thousands of devices.

The computing device may take the summation 2405 of the points for one or more of the devices in the group (e.g., all of the devices). The computing device may perform a standard deviation function on the result of the summation of data points. Because the skewed data was removed, a relatively evenly distributed population of information may result.

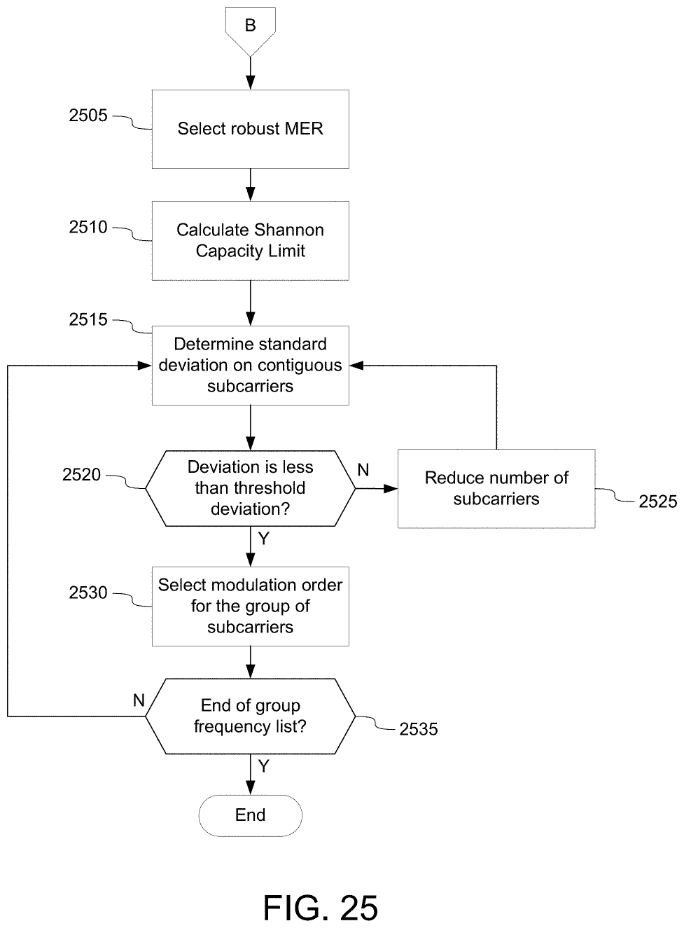

FIG. 25 shows at least a portion of a method for determining one or more data modulation profiles for groups of devices. The method may be performed by one or more computing devices of the system (e.g., the external database 1510, the profile manager 1515, the termination system 1505, etc.), but some or all steps could be performed by one or more other computing devices. For example, one or more of the external database 1510, the profile manager 1515, the termination system 1505, and/or the user device 1520 may perform one or more different steps of the method. One or more of the steps shown in FIG. 25 may be used to determine one or more modulation (e.g., OFDM) profiles for one or more devices. Profiles for a device group may be selected based on the MER and spectrum analysis data, as described herein. Moreover, a particular modulation profile may be used on contiguous subcarriers. Contiguous subcarriers may, for example, use adjacent frequencies. In general, one or more computing devices of the system may assign the same modulation profile to a group of contiguous subcarriers, as will be described in detail below. Exemplary modulation profiles (or orders) may include, but are not limited to, BPSK, QPSK, 16 QAM, 64 QAM, 256 QAM, 512 QAM, 1024 QAM, 2048 QAM, 4096 QAM, 8192 QAM, 16384 QAM, etc.

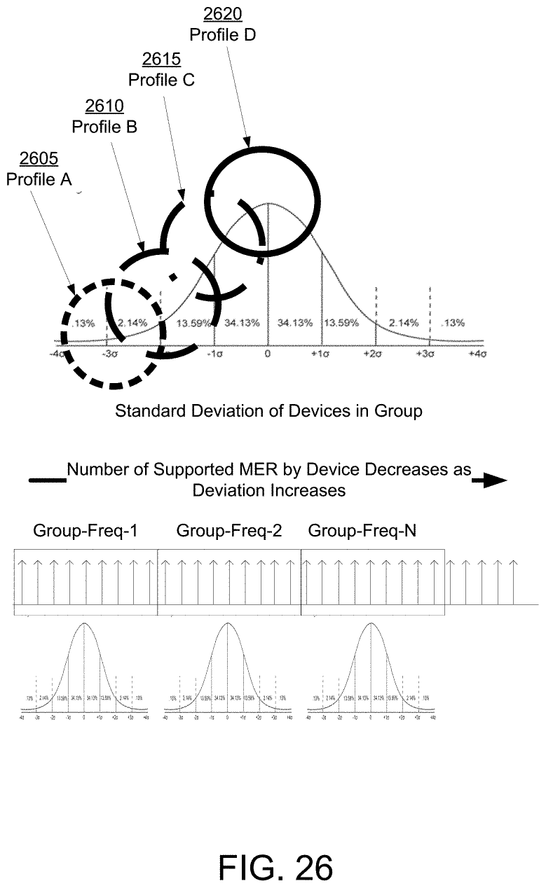

In step 2505, the computing device may select a robust MER for a group of subcarriers (e.g., contiguous subcarriers). The robust MER (and its corresponding modulation order) may support the greatest number of devices, a threshold number of devices, and/or a certain ratio of the device population. For example, the computing device may select the MER at a certain number of standard deviations from the mean, such as −3 standard deviations from the mean, and/or may select the minimum MER measured for the device population (excluding skewed data). With brief reference to FIG. 26, profile A 2605 may correspond to the group of devices having MERs greater than or equal to the MER at −3 standard deviations from the mean. The selected robust MER at −3 standard deviations may be, for example, an MER value of 31.

Returning to FIG. 25, in step 2510, the computing device may calculate the Shannon Capacity limit, e.g., the theoretical maximum channel capacity (CC) at a low error rate, for the selected error rate metric (e.g., MER, SNR, CNR, etc.). If SNR is used as the indicator for error rate, the computing device may compute CC=log₂(1+SNR). If carrier-to-noise ratio (CNR) is used as the indicator for error rate, the computing device may compute CC=log₂(1+CNR). The Shannon-Hartley theorem may be used for any signal to noise ratio in the digital realm, e.g., MER. For example, the power to amplitude may be used instead of the SNR or MER. The computing device may factor in one or more weights in the algorithm. CC may be expressed as bits per symbol or bits per hertz. The channel capacity may indicate the coding bandwidth. The computing device may use a floor function on the result (e.g., CC).

If MER is used as the indicator for error rate, the computing device may calculate the capacity CC=log₂(1+10^{MER}^{_{/10}}). For example, for an MER of 31, the channel capacity CC=log₂(1+10³¹^{_{/10}})=log₂(1+1258.9)=log₂(1259.9)=10.29 bits per symbol. The computing device may use the floor function on CC (e.g., floor[10.29]), which results in 10 bits per symbol. In order to calculate the modulation order, the computing device may apply the following formula: Modulation Order=2^{floor[CC]}=2¹⁰=1024. For an MER of 31, the computing device may select 1024 QAM as the modulation profile. 1024 QAM may support MERs of 31 and higher. Accordingly, carriers with higher MERs (e.g., 33 MER or 34 MER) can also be supported by 1024 QAM, and these carriers are also candidates for the 1024 QAM modulation profile (or potentially higher order modulation profiles). The computing device may assign subcarriers with MERs lower than 31 to lower-order modulation profiles, such as 256 QAM or 512 QAM.

In step 2515, the computing device may determine (e.g., compute) a standard deviation of MER on the selected group of contiguous subcarriers (e.g., N number of subcarriers). The contiguous subcarriers may be used over the same frequency band and/or frequency channel. The computing device may include any number of subcarriers in each group of contiguous subcarriers. With reference to FIG. 26, the computing device may include nine subcarriers in each frequency group (e.g., Group-Freq-1, Group-Freq-2, Group-Freq-N, etc.). Any number of subcarriers can be included in the groups, such as 50 subcarriers, 100 subcarriers, etc. Moreover, a frequency group may have the same number of subcarriers as another frequency group, or may have a different number of subcarriers as the different frequency group. For example (and for modulation profile A 2605), the computing device may target a −3 deviation. The computing device may take the −3 deviation of each subcarrier group.

Returning to FIG. 25, in step 2520, the computing device may determine whether the deviation calculated for the selected modulation profile (e.g., Profile A 2605) is less than a threshold deviation (e.g., 0.5). If the deviation is more than the threshold deviation, one or more computing devices of the system may undesirably cause interference to a different modulation order or profile. The computing device may attempt to keep the deviation as small as possible (e.g., less than 0.5). With reference to FIG. 26, a tight fit by a small deviation may graphically be indicated by the subcarrier arrows in a particular frequency group being approximately the same or similar magnitude. Returning to FIG. 25, if the deviation is less than the threshold deviation (step 2520: Y), the computing device may proceed to step 2530, which will be described in further detail below. If the deviation is not less than the threshold deviation (step 2520: N), the computing device may proceed to step 2525.

In step 2525, the computing device may reduce the number of subcarriers if the deviation is not less than the threshold deviation. The computing device may reduce the number of subcarriers by a predetermined amount, such as 25%. For example, if there are 100 subcarriers in the group, the computing device may remove 25 of the subcarriers. If the computing device can identify which subcarrier(s) are causing the standard deviation to be above the threshold deviation, the computing device may remove those subcarrier(s) directly. If the computing device does not identify specific subcarrier(s) to remove, the computing device may simply reduce the number of subcarriers to generate a new group of contiguous subcarriers. The computing device may repeat step 2515 and determine the standard deviation on the new group of contiguous subcarriers. In step 2520, the computing device may determine whether the standard deviation for the new group of contiguous subcarriers is below a threshold deviation. The computing device may repeat this loop until the number of contiguous subcarriers is reduced to a point where the standard deviation for the group is less than a threshold deviation. Accordingly, the computing device may group as many user devices together with the same modulation order, without violating one or more criteria (e.g., threshold standard deviation and/or other criterion).

The computing device may determine to simulate one or more profiles using the standard deviation as an evaluation parameter. For example, the computing device may determine that the standard deviation is not less than the threshold standard deviation, and may determine to modify the one or more profiles, for example, if the standard deviation is not less than the threshold standard deviation. The profile simulator 215 may determine one or more profiles that comprise the one or more subcarriers that cause the standard deviation to be above the threshold deviation, and may simulate the determined one or more profiles using one or more simulation methods described herein. The profile simulator 215 may use other parameters, such as a mean MER, as evaluation parameters to calibrate simulation settings and/or to generate additional profile analysis results.

In step 2530, the computing device may select a modulation profile for the group of subcarriers. Exemplary modulation profiles (or orders) include, but are not limited to, BPSK, QPSK, 16 QAM, 64 QAM, 256 QAM, 512 QAM, 1024 QAM, 2048 QAM, 4096 QAM, 8192 QAM, 16384 QAM, etc. The modulation profile may be determined by accessing data associating standard deviations from the mean with a modulation profile (e.g., a table associating X standard deviation with profile A, associating Y standard deviation with profile B, associating Z standard deviation with profile C, and so forth). For example, −3 standard deviations may be assigned a modulation profile A 2605, as shown in FIG. 26, and user devices with a modulation profile A may use a modulation order of 1K QAM. The computing device may additionally or alternatively determine the appropriate modulation profile based on the Shannon Capacity limit, as previously described. The computing device may assign a modulation profile without a low density parity check code (LDPC).

In step 2535, the computing device may determine whether it has reached the end of the group frequency list. The computing device may assign modulation profiles for each group of subcarriers in a channel or block, such as in an OFDM block. If the computing device has not reached the end of the group frequency list (step 2535: N), the computing device may repeat step 2515 to identify the additional group of subcarriers and determine its standard deviation(s).

FIG. 26 shows an example of determining one or more data modulation profiles for one or more devices in a group. The top standard deviation curve shown in FIG. 26 may result from the summation shown in FIG. 24. FIG. 26 shows an assignment of four different profiles (A, B, C, and D), but any number of profiles may be used. Devices in a group of devices (e.g., in a serving group) having MERs at −3 standard deviations from the mean MER for the group of devices may be assigned profile A 2605. Profile A 2605 may be a lower-order modulation profile, such as 256 QAM or 1K QAM. Devices in the group of devices having MERs at −2 standard deviations from the mean MER for the group of devices may be assigned profile B 2610. Profile B 2610 may be a low to mid-order modulation profile, such as 2048 QAM. Devices in the group of devices having MERs at −1 standard deviation from the mean MER for the group of devices may be assigned profile C 2615. Profile C 2615 may be a mid to high-order modulation profile, such as 4096 QAM. Devices in the group of devices having MERs at 0 standard deviations from the mean MER for the group of devices may be assigned profile D 2620. Profile D 2620 may be a high-order modulation profile, such as 8192 QAM. The remaining devices may be assigned to profile D 2620. The computing device may assign one or more higher-order modulation profiles to the remaining devices. Whether high-order modulation profiles are assigned may depend on which modulation orders and/or the number of modulation profiles supported by each device and/or the termination system. Moving from left to right (e.g., as the deviation increases), the number of supported devices (e.g., cable modems) may decrease. At −3 standard deviations, nearly all of the devices may be supported by profile A. Fewer devices may be supported by profile B, and so on.

As described above, one or more of the steps shown in FIG. 25 may be repeated until each group of contiguous subcarriers is assigned to a modulation profile. Group-Freq-1 subcarriers shown in FIG. 26 may be assigned to one modulation profile, Group-Freq-2 subcarriers shown in FIG. 26 may be assigned to another modulation profile, Group-Freq-N shown in FIG. 26 subcarriers may be assigned to yet another modulation profile, and so on.

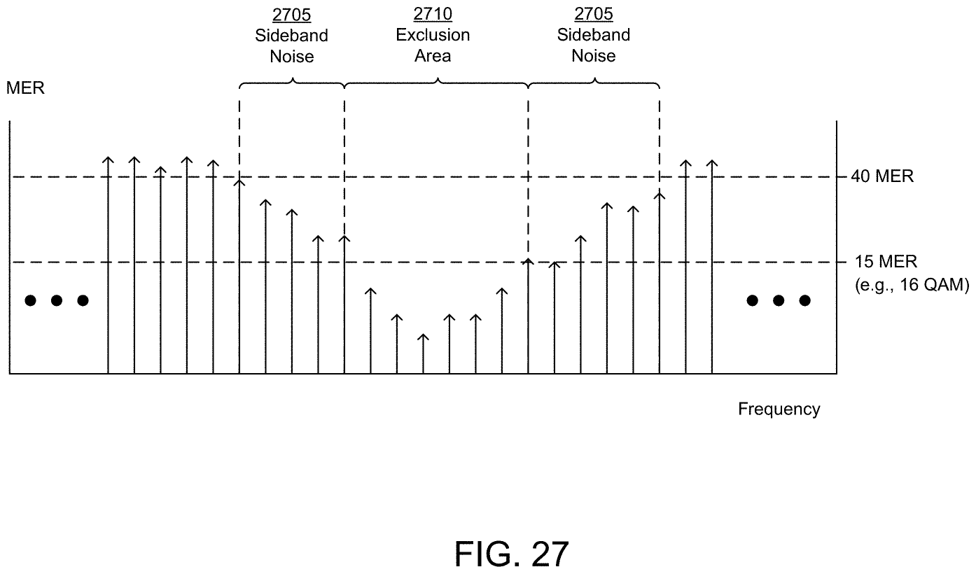

FIG. 27 shows an example of assigning modulation profiles. Each arrow may represent a plurality of subcarriers on one or more channels (e.g., OFDM blocks). The subcarrier MERs may be relatively high at certain frequencies (e.g., at or near 40 MER) to the left and the right side. However, noise at a certain frequency or frequency band may affect one or more computing devices of the system, and may reduce certain subcarrier MERs (e.g., near the middle). The noise may include sideband noise 2705 that reduces the MER of certain subcarriers. The noise may also be centralized at a certain frequency, which may significantly reduce the MER of some subcarriers.

Using one or more of the method steps and/or algorithms described above, a computing device may assign different modulation profiles to the subcarriers outside of the frequencies affected by noise, the subcarriers affected by sideband noise, and the subcarriers in the exclusion area 2710. The computing device may determine a minimum MER (or Shannon Capacity MER), such as 15 MER. With respect to the subcarriers affected by sideband noise, the computing device may calculate the channel capacity CC=log₂(1+10¹⁵^{_{/10}})=log₂(1+31.6)=log₂(32.6)=5.03 bits per symbol. The computing device may use the floor function on CC (e.g., floor[5.03]), which results in 5 bits per symbol. To calculate the modulation order, the computing device may apply the following formula: Modulation Order=2^{floor[CC]}=2⁵=32. For an MER of 15 (which may be the minimum MER), the computing device may select 32 QAM as the modulation profile. If 32 QAM is not available, the computing device may select the next available (lower order) profile, such as 16 QAM, as shown in FIG. 27. Accordingly, the subcarriers affected by sideband noise 1705 may be assigned a modulation profile of 16 QAM. The computing device may further divide these subcarriers and assign some of the subcarriers affected by sideband noise to high order modulation schemes.

With respect to the subcarriers not affected by noise, the computing device may calculate the channel capacity CC=log₂(1+10⁴⁰^{_{/10}})=log₂(1+10000)=log₂(10001)=13.29 bits per symbol. The computing device may use the floor function on CC (e.g., floor[13.29]), which results in 13 bits per symbol. To calculate the modulation order, the computing device may apply the following formula: Modulation Order=2^{floor[CC]}=2¹³=8192. Therefore, for an MER of 40, the computing device may select 8192 QAM as the modulation profile. Accordingly, the one or more of the subcarriers not affected by noise may be assigned a modulation profile of 8192 QAM.

With respect to the subcarriers in the exclusion area 2710 (which may be significantly affected by the noise), the computing device may exclude these subcarriers from the calculation and create a different type of profile for these subcarriers, as described above with reference to at least FIGS. 18, 20, and 21. For example, the data for these subcarriers may be skewed. The computing device (or other back end device) may send instructions to the user device(s) or user device group(s) to change to the new modulation profile, for example, based on a determination of an updated modulation profile for one or more user devices of a user device group.

One or more methods of measuring error ratio may be used, such as measuring receive (or transmit) power. With respect to cable modems, there may be a large number of DOCSIS 3.0 devices present in the network during a transition to DOCSIS 3.1 devices. The DOCSIS 3.0 devices may be instructed to scan and measure OFDM subcarriers from DOCSIS 3.1 transmissions, even if the DOCSIS 3.0 devices are not able to fully take part in the DOCSIS 3.1 transmissions. The frequency spectrums utilized by the DOCSIS 3.0 devices may be channelized. One or more computing devices of the system may use the carrier receive power (e.g., instead of MER) to determine the appropriate modulation profile using the methods previously described. If a channel has a large loss of power, a lower order modulation scheme may be used for that channel.

During the transition period from the DOCSIS 3.0 devices to DOCSIS 3.1 devices, continuous support for DOCSIS 3.0 devices may be necessary for many years. This transition period may be protracted. As previously described, demodulating OFDM subcarriers (including MER data) may provide a feedback mechanism for profile selection. A similar method may be used for legacy user devices (e.g., a population of DOCSIS 3.0 cable modems). Although these modems might not be able to participate in the DOCSIS 3.1 communications, they may still measure signal quality. Depending on the DOCSIS 3.0 chip family, the capabilities may vary, but most or all of the DOCSIS 3.0 devices can provide at least some data to a profile selection algorithm.

An existing deployed population of devices may be used to analyze and understand the profile domains within service groups, e.g., amplifiers or even smaller level of network components may be used. The performance of each spectrum may be used as a first order approximation prior to replacing the existing devices with new devices. Accordingly, service performance may be predicted before the existing devices are replaced. For example, one or more computing devices of the system may determine the best (or one of the best) physical layer links (PHY-links) for a given modem population of a given service group. Metrics for measuring quality may include speed and/or reliability. One or more computing devices of the system may look at physical layer assignments, and attempt to create maximum performance out of the subcarrier assignments for each group.

One or more computing devices of the system may determine profiles before deploying DOCSIS 3.1-capable equipment. For example, DOCSIS 3.0 equipment may be triggered to provide information useful for transitioning to a DOCSIS 3.1 environment. These existing devices may be instructed to scan and measure, for example, OFDM subcarriers from DOCSIS 3.1 transmissions (e.g., from a termination system or other back end device), without actually being able to perform a successful communication according to DOCSIS 3.1 protocols. Accordingly, one type of device may be used to analyze the spectrum in preparation for the appointment of different types of devices. A device with a spectrum analyzer (e.g., a set top box) may be instructed to approximate which profile to assign to the new device when the new device joins one or more computing devices of the system (e.g., the termination system 1505, etc.). The new device may be temporarily assigned to a group based on the information from the legacy device, prior to upgrading to the new device. Accordingly, the population of existing devices (e.g., DOCSIS 3.0 devices) may be used to make the profile selection process for new devices (e.g., DOCSIS 3.1 devices) more efficient and faster.

One or more computing devices of the system described herein may detect devices with broken or malfunctioning components, and assign new profiles for the devices with broken components (e.g., transmitters, receivers, memory, certain chips, etc.) such that the device functions with a particular quality of service (QoS). Many devices in a network (e.g., hundreds, thousands, or tens of thousands) may have broken or malfunctioning components, and it may be difficult to immediately fix or replace all of these broken components (or the device itself). Advantageously, one or more computing devices of the system may instead assign one or more new profiles to the devices with broken components so that the devices at least functions as reliably as possible (with the broken component) and/or with a certain QoS.

Features described herein may be used to prioritize device upgrades (e.g., to DOCSIS 3.1). If the devices are performing poorly (e.g., low MER, low receive or transmit power, low SNR, broken component(s), other network issues, etc.), one or more computing devices of the system may prioritize upgrading these devices. For example, if these poor-performing devices are DOCSIS 3.0 devices, one or more computing devices of the system may prioritize their upgrade to DOCSIS 3.1 devices. One or more computing devices of the system may prioritize upgrades with or without first determining whether one or more computing devices of the system can improve their reliability and/or QoS by assigning a new profile.

A method for determining modulation profiles may comprise determining a plurality of devices in the network (e.g., mobile devices, set-top boxes, cable modems, etc.) that use a particular communication protocol, such as DOCSIS 3.0. A server or other backend device, such as a termination system, may receive, from one or more of these devices, data indicative of the signal quality at the device (e.g., receive power, transmit power, SNR, etc.). One or more computing devices of the system may channelize or otherwise divide the spectrum for the devices. One or more computing devices of the system may determine (e.g., approximate) one or more subcarriers based on the channelization. An approximation of the receive power may be determined, such as via a subcarrier power analysis. One or more computing devices of the system may process data of the receive power to generate one or more profiles for the existing network device and/or for future devices expected to replace the existing devices.

A computing device may determine a plurality of devices in a network (e.g., mobile devices, set-top boxes, cable modems, etc.) that use a particular communication protocol, such as DOCSIS 3.0. As described above, the plurality of devices may comprise a particular group of devices, such as a serving group or a group of devices in a particular region or area. The computing device may receive, from one or more of the plurality of devices in the network, data indicative of the signal quality at the device. The data may comprise MER data. However, if the MER data is not available or feasible for the device, the device may send other types of data indicative of signal quality, such as receive power, transmit power, SNR, etc.

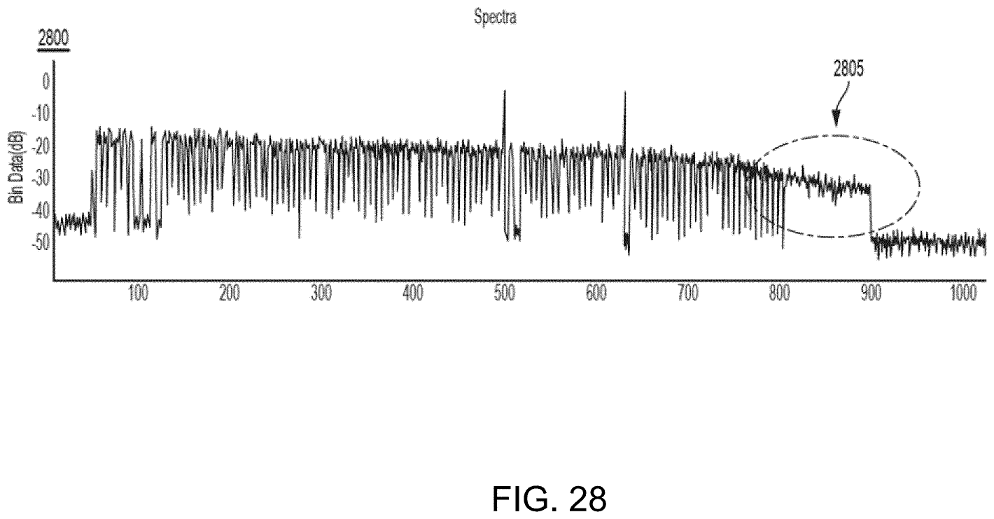

FIG. 28 shows an example 2800 of spectrum data from a device in the network. For example, the data may comprise raw spectrum received from a DOCSIS 3.0 device (e.g., an existing set top box). The horizontal axis of FIG. 28 may indicate frequency (e.g., in MHz) and the vertical axis of FIG. 28 may indicate a signal power (e.g., in bin data (dB)). A computing device may receive spectrum data from numerous devices, such as 18 million devices, 34 million devices, or any other number of devices. The spectrum may include an OFDM signal 2805, such as a DOCSIS 3.1 OFDM signal, as circled in FIG. 28. Accordingly, the computing device may receive some measurement of the OFDM channel, including one or more (e.g., all) of the subcarriers.

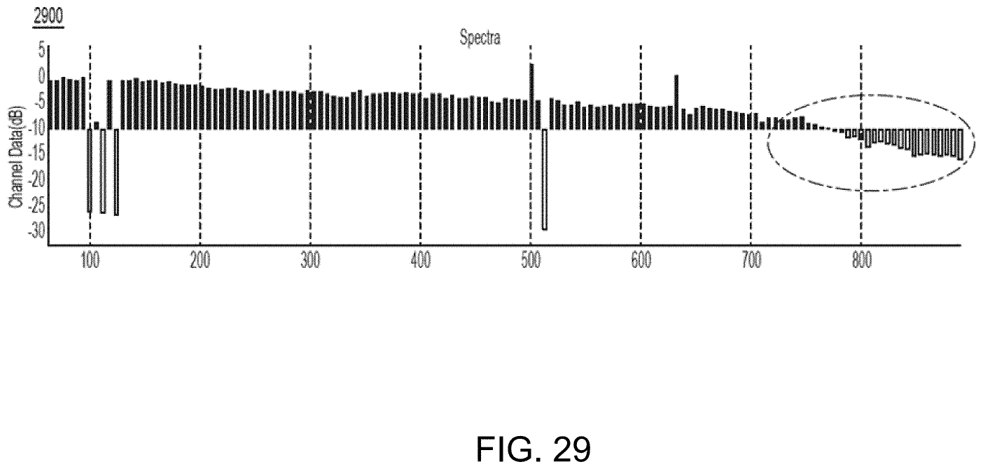

The computing device may channelize or otherwise divide the spectrum (e.g., the data comprising the raw spectrum) for the devices. The computing device may channelize individual subcarriers, and the channelized data may be provided to the profile management routine previously described. FIG. 29 shows an example 2900 of channelized spectrum data. Any channel width may be used. The horizontal axis of FIG. 29 may indicate frequency (e.g., in MHz) and the vertical axis of FIG. 29 may indicate a signal power (e.g., in channel data (dB)). FIG. 29 shows dividing a spectrum up to a channel width of 6 MHz. Each channel may comprise a plurality of subchannels. For example, if a subchannel is 50 kHz, the 6 MHz channel may be divided into 120 subchannels, each subchannel having a corresponding subcarrier. One or more computing devices of the system may additionally or alternatively channelize at a subcarrier level. In this example, the subcarriers have been channelized in 6 MHz blocks, but data could be processed at any resolution.

The computing device may determine (e.g., approximate) one or more subcarriers based on the channelization. For example, instead of having six MHz channel blocks, the computing device may analyze actual subcarriers. As will be described below, instead of (or in addition to) using subcarrier MER or subcarrier LDPC performance as described above, the computing device may use subcarrier receive power to determine one or more modulation profiles.

The computing device may determine an approximation of the receive power, such as via a subcarrier power analysis. A gross approximation on a subcarrier basis may be performed. One or more existing devices might not have the capability within, e.g., its tuner to lock the subcarriers. However, the device may be able to precisely dial in the start and stop frequencies and/or the periodicity of the subcarrier spacing so that the device can very accurately measure the receive power of each individual subcarrier. These devices may use spectrum power measurement to add to the feedback/decision making tree noted above.

In the context of DOCSIS 3.0 devices, many or most of these devices may be able to participate using raw spectrum analysis. The OFDM subcarriers can be soft-tuned and measured for subcarrier power. This may provide a coarse-grained understanding of the subcarrier channel performance, including the effect of certain RF issues, such as rolloff, notching, and suckouts.

The computing device may process the data, including the receive power, to generate one or more profiles for the existing network device and/or for future devices expected to replace the existing devices. Based on the data, the computing device may identify one or more channels or one or more subchannels that cause a high data error rate. The computing device may configure the device group that operates using those channels or subchannels with a lower modulation order. There are several different ways of grouping devices together, including the clustering features described above, cross-correlation routines, and linear graphing, among other types of algorithms.

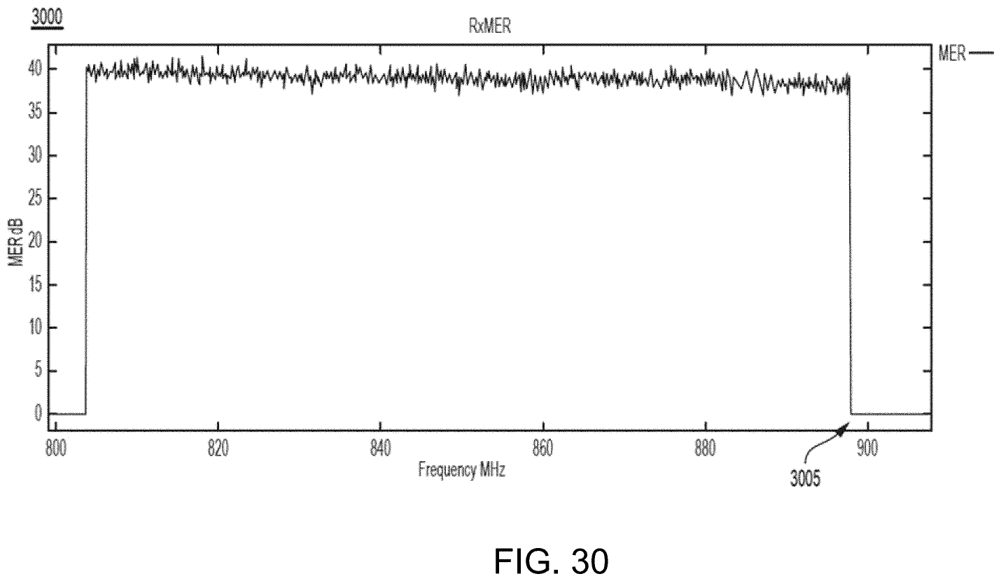

FIG. 30 shows an example 3000 of MER (e.g., OFDM MER) versus frequency for a user device. Absent from FIG. 30 are the standard deviations and population variances. However, the data of FIG. 30 may be used to inform the standard deviations and/or population variances. FIG. 30 shows a spectrum between approximately 800 and 900 MHz. Above 880 MHz and below 900 MHz, the computing device may start to see an MER drop-off or tailoff 3005. This may show the total population measurements of the MER frequency. The computing device may also calculate a cross-correlation of power and MER (not shown).

Another representation of data indicating quality of signal received by a user device may comprise frequency versus power (e.g., instead of or in addition to frequency versus MER, as shown in FIG. 30). Based on the data, the computing device may approximate a subcarrier to noise ratio. That is, although the user device might not actually be able to demodulate a certain type of signal (e.g., using MER data), the computing device may extrapolate MER data based on power data received from the population of devices. This is because the power profile of a subchannel may have a cross-correlation to the MER of that subchannel. Because of the strong statistical correlation, the computing device may make sub-approximations of what service group to initialize a new device (e.g., a DOCSIS 3.1 modem) in before having actual MER data. Advantageously, modulation profiles may be selected before DOCSIS 3.1 devices are rolled out.

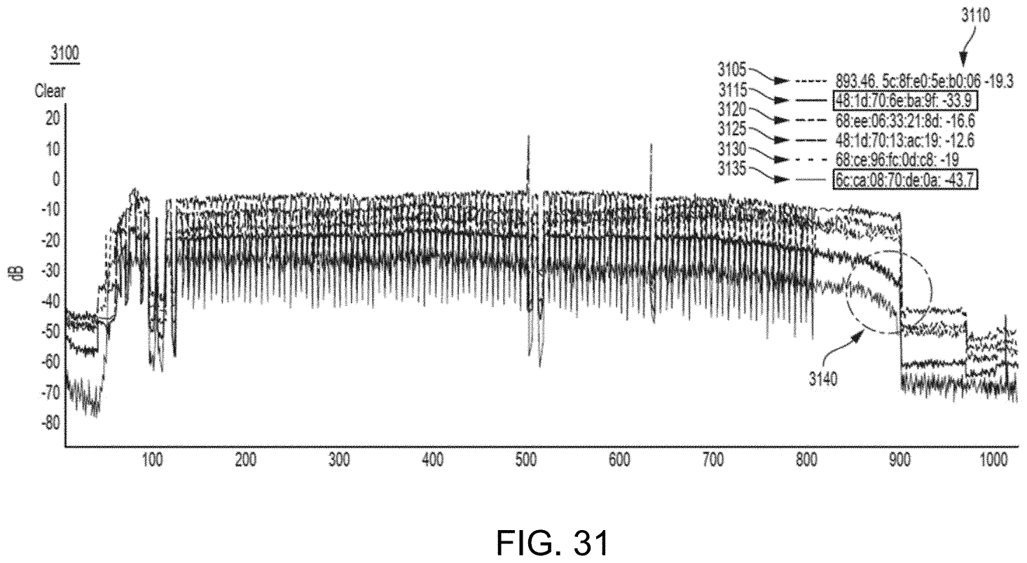

FIG. 31 shows an example 3100 of OFDM analysis using non-OFDM devices. The Y axis may be BIN-power, and the X axis may be frequency. An exemplary OFDM channel may be between 800 and 900 MHz. The computing device may select an individual frequency marker for analysis, such as 893.46 MHz (indicated at the top right of the graph 3105). Data from different devices (e.g., DOCSIS 3.0 devices) may be represented in different signals (e.g., signals 3105, 3115, 3120, 3125, 3130, and 3135). The devices may be in the same group, such as a service group. The different devices may be indicated by their MAC address or other identifier. The first device 3105 may have a power of −19.3 dB. The second device 3115 may have a power of −33.9 dB. The third device 3120 may have a power of −16.6 dB. The fourth device 3125 may have a power of −12.6 dB. The fifth device 3130 may have a power of −19 dB. The sixth device 3135 may have a power of −43.7 dB.

As shown in FIG. 31, two devices at the frequency marker of 893.46 MHz may have excessive rolloff (e.g., the second device 3115 with a power level of −33.9 dB and the sixth device 3135 with a power level of −43.7 dB). These devices may be eligible for a special profile, replacement, etc. Where there is a circle 3140 around the two traces for those devices, there may be a cluster of devices that experience degraded performance because the receive power is experiencing a low loss. That may be caused by a piece of equipment that is damaged or not supposed to be there. Devices with rolloff may have broken components. Accordingly, one or more computing devices of the system may proactively identify network elements that might need repair. However, numerous broken devices may exist, and immediately repairing them all may be impractical. Instead, one or more computing devices of the system may assign an appropriate profile so that the device functions as reliably as possible, e.g., prior to repair, replacement, upgrade, etc.

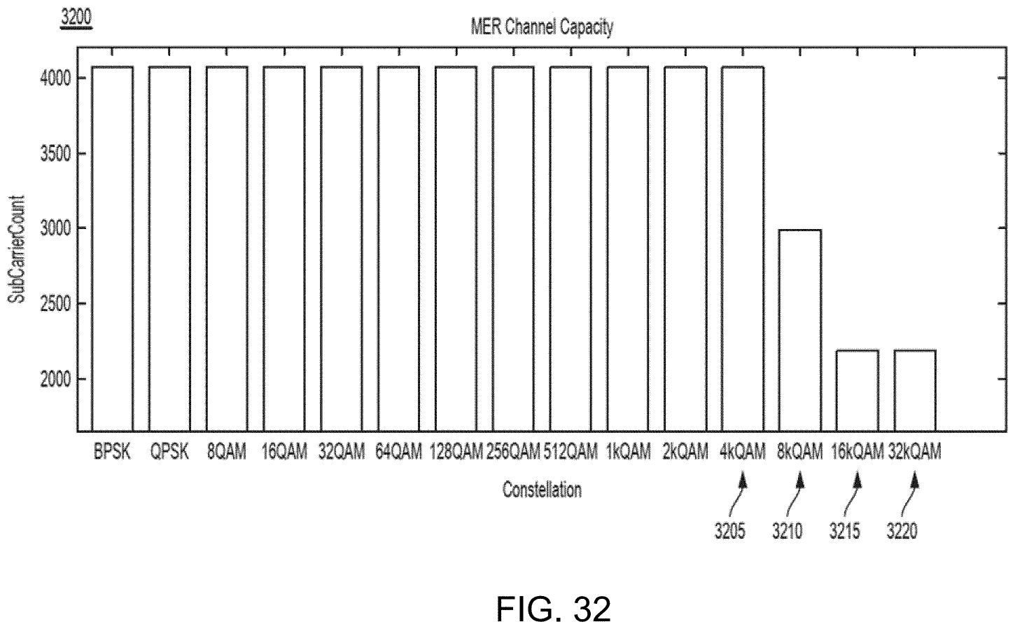

FIG. 32 shows an example 3200 of a subcarrier count per modulation order. For example, data shown in FIG. 32 may indicate OFDM Shannon Channel Capacity versus bits-per-symbol of a single OFDM, such as via PNM MER RxData. 4K QAM 3205 may be the maximum channel capacity without error (theoretical). However, one or more computing devices of the system may attempt to assign well-functioning devices at 8K QAM (or higher) at certain frequencies. As previously described, a Shannon analysis may be performed to determine the performance based on the MER. Certain frequencies may perform better than others, and in particular, the devices that tailoff might not perform as well.

Each bar shown in FIG. 32 may indicate, based on Shannon's limit, the subcarriers within Shannon's limit for each individual constellation or modulation order. At the current snapshot of the MER capture, one or more computing devices of the system may determine that every subcarrier can support 4K QAM. Every subcarrier can also support 256 QAM, 512 QAM, among other lower order QAMs. Approximately 3000 subcarriers, which may be a little more than half of the subcarriers, may support 8K QAM 3210. As one moves to higher-order modulations, fewer and fewer subcarriers may be supported. Approximately 2,200 subcarriers can use 16K QAM 3215 or 32K QAM 3220 modulations. As previously described, because one or more computing devices of the system knows which subcarriers do not support higher modulations, one or more computing devices of the system may compute the standard deviation for each subcarrier and group the subcarriers by frequency. Accordingly, one or more computing devices of the system may be able to tailor a high performance OFDM because one or more computing devices of the system knows which subcarriers can perform over time and make the best estimation. From this, one or more computing devices of the system may determine/customize groupings based on modem population.

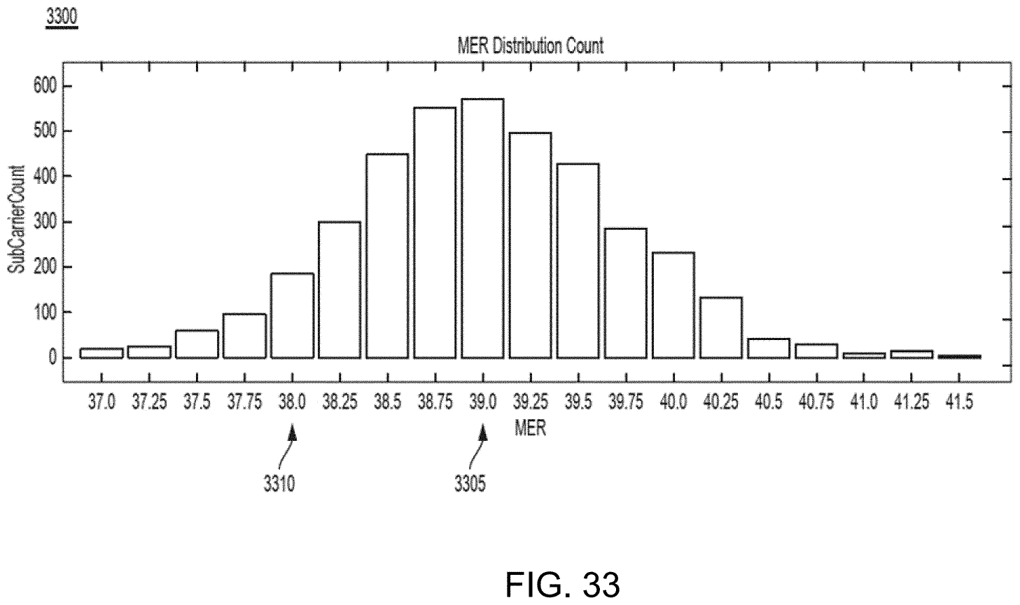

FIG. 33 shows an example 3300 of MER distribution of a single OFDM channel. The data represented in FIG. 33 may be taken from the same RxMER data capture as FIG. 32. FIG. 33 shows the distribution of the subcarriers. Two deviations may be analyzed: one per subcarrier of a given population of devices and another over frequency in order to determine the best contiguous number of subcarriers that can perform at a high level. The mean MER 3305 may be around 39, and the first standard deviation 3310 may be around 38. This may give one or more computing devices of the system 66% coverage of the devices. One or more computing devices of the system may determine minimum and maximum values.

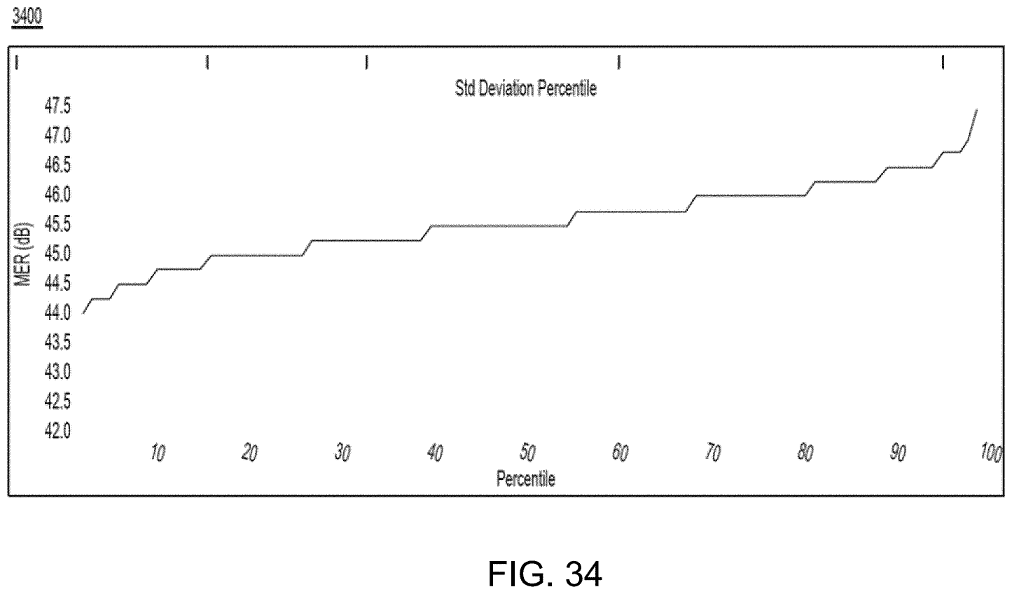

FIG. 34 shows an example 3400 of standard deviation of MER versus percentile of a single OFDM channel. The data shows an S-curve response.

To implement one or more features described herein, existing (e.g., DOCSIS 3.0) devices may utilize software defined radios (SDR), which can be field upgraded. One or more of these devices may be able to demodulate OFDM pilot signals, for example, if they are field upgraded. This may provide better visibility to additive interference, such as LTE, GSM, and VHF, and one or more features described herein may be used. However, one or more features described herein may use a more comprehensive set of data for determining modulation profiles or for determining devices that require repair or replacement. In addition to power data, the algorithm may receive data such as MER data, LDPC/FEC performance data, and the like.

One or more features described herein may also be used for performance certification of certain types of devices, such as DOCSIS 3.1 devices and/or service groups. Communications operators may use one or more features described herein to identify problematic areas in the spectrum, prior to deploying DOCSIS 3.1 devices.

Features described herein may also be useful for anticipating the maximum throughput for a user device before the user device is offered a service. For example, if a neighborhood only supports 256 QAM, the maximum speed may be less than the speed with 1024 QAM. The customer may be informed of the type of service the customer is expected to receive.

One or more of the analyses (e.g., steps or algorithms) described above may be performed on either a server (e.g., the termination system 1505) or an end-point device (e.g., user device 1520). End-point devices conditioning data before sending the data to the server (e.g., termination system and/or CMTS) may result in technical efficiencies in storing and processing data.

DOCSIS 3.1 provides frequency and time domain information analysis that may be offloaded to an external analysis and analytical tool. The user device (e.g., a cable modem) may expose functionality to a user to perform an analysis. An endpoint may comprise a Proactive Network Monitoring/Maintenance (PNM) tool. One or more computing devices of the system may include an external analysis tool, such as a Profile Management Application (PMA) tool.

Endpoint processing offers numerous advantages. A technician may use frequency spectrum analysis tools in the endpoint to analyze the RF signal reaching the endpoint. The analysis may be used on devices in different rooms of a house or other structure, and based on the analysis, the technician may learn about the RF backbone network and RF network into each room. The technician may obtain help by having the data monitored remotely at, for example, the headend. The second level help could log on and see what the technician is seeing and help the technician analyze the data.

One or more analysis and analytical tools may be moved on to the endpoint, removing the need to access an external tool as a proxy. Operations, such as on-demand scheduling for data, may be moved from the external tool into the endpoint. This may allow the external tool to collect data as it comes in and perform operations and decisions on how to address issues (e.g., MERs, data errors, etc.) that the endpoints have measured and/or analyzed. For example, one or more computing devices of the system may collect PNM data and react based on massive polling of a plurality of devices and CMTSs, as previously described. The polling may be reduced by instructing the devices to perform the analysis on the devices and to automatically upload the data to a repository for later aggregate analysis. Some analyses may be performed by an endpoint to alleviate processing load at one or more devices of (e.g., the termination system 1505, the database 1510, the profile manager 1515, etc.), and to reduce at least some of mass amounts of data that is going to be processed at the one or more computing devices of the system (e.g., the termination system 1505, the database 1510, the profile manager 1515, etc.). For example, in the field, analyses can be determined by the client devices. A technician may come in and can leverage the device itself as the tool.

A device, such as a cable modem, may measure MER and forward value(s) for per-subcarrier MER to a PNM application, which may be used to perform statistical analysis on the received data. For example, the received data (e.g., the MER and/or values for per-subcarrier MER) may be used to determine modulation schemes for one or more subcarriers. The device may perform one or more transformations of the data before sending the data to a central location. The device may use a built-in (or external) RF spectrum analyzer, vector analyzer (e.g., a small scale vector analyzer), and/or network analyzer (e.g., a small scale network analyzer) to perform these transformations. For example and in a cable environment, a network analyzer in conjunction with a CMTS may be used to determine the health of the CMTS, the health of the modem's frontend, and the quality of data between the two points.

A cable modem and the CMTS may work in conjunction. The CMTS may indicate that it is going to send the cable modem information, and the cable modem may receive the information having a particular time stamp. The cable modem may implement one or more algorithms to determine the expected values versus the values indicated by the information it has received. The cable modem may upload that data in a particular format, such as raw format. The data may comprise coefficients of the OFDM. The CMTS may perform additional analyses based on the data it receives from the cable modem.

A network analyzer may measure certain details, such as reflections and transmissions. The network analyzer may send various parameters, such as S parameters, Y parameters, and Z parameters. Those signals may be analyzed. One endpoint device may send a test signal, and another endpoint device may analyze the signal. One or more of the endpoint devices may have the ability to adjust various parameters for amplifiers and filters. S parameters might not be adjusted at the cable modem, but rather during post analysis (e.g., post capture).

The one or more endpoint devices may include a channel estimator. A channel estimation may be performed by using one or more coefficients to determine one or more vector errors. The amount of error may be determined based on the channel estimation.

The one or more endpoint devices may include a vector analyzer. The vector analyzer may analyze frequency domains, modulation domains, code domains, time domains, etc., in order to determine what OFDM subchannels and which modulation schemes are supported. The endpoint device may request appropriate modulation schemes.

User interfaces may be provided to allow a user, technician, or engineer at the location of the endpoint to access particular data and analytics. The user may use an external tool or browser to view RF signals and perform analyses that originate at the endpoint.

RxMER values may be included in a file, such as a binary file. The first 20-30 bytes of the file may identify the cable modem, when the data capture occurred, what downstream channel was used, the MAC address, and/or the start frequency, among other information. The remaining data may comprise one or more magnitude values. Consecutive magnitude values may correspond to each individual subcarrier.

An external system may leverage the computing power of the one or more endpoint devices by having the one or more endpoint devices perform the mathematical operation(s) on data (e.g., raw data) that might typically be performed at the external system. This may be incorporated into a software stack for the one or more endpoint devices. A distributive architecture may be used, and analysis may be assigned to the one or more endpoint devices. The distributive processing system may enable a technician who might not have the credentials to access certain core backbone system features and analysis tools to access information at the one or more endpoint devices.

The one or more endpoint devices may be instructed to automatically upload data at any time interval and/or over any number of iterations. For example, a job may be set up on the one or more endpoint devices. One or more computing devices of the system may communicate with the devices and instruct a routine upload of data at a particular interval, e.g., instead of constant interaction between the one or more endpoint devices and the one or more computing devices of the system requesting data. Advantageously, traffic may be alleviated on the control plane between the one or more computing devices of the system and the one or more endpoint devices.

The one or more computing devices of the system may add the ability for endpoint devices to perform some analysis and upload data to one or more computing devices at a more centralized location so that the one or more computing devices at the more centralized location could poll information dynamically from the endpoint and/or perform additional analyses to draw conclusions. The analysis may be performed across the larger spectrum of the network, and not just by a particular endpoint device. By collecting the data and processing the data, one or more computing devices of the system may identify the correct location in the network that an error is occurring. This may inform appropriate deployment of remedies to fix the error(s). The network may save resources by not sending a technician to a user location (e.g., a house) if the error is in the node or in the headend.

Additional processing may be performed in one or more computing devices of the system. For example, a portion of data from a DOCSIS cable modem (or from any other endpoint) may be moved to a central computer for processing, and the central computer may perform analysis on thousands of endpoint devices.

Generating modulation profiles or adaptive bit-loading may result in a significant amount of data generated and/or stored. For example, assume that each OFDM data capture by a user device contains 8 KB of data per 192 MHz OFDM channel, which may be, for example, up to 2 per user device (for 16 KB for user device). An estimate of 500 user devices per serving group (SG) may result in 8 MB of data from a single capture event. A sample interval, for example, of every 6 hours, may result in 32 MB of data from a single serving group per day. Assuming, for example, 6 million user devices (e.g., cable modems), the resulting data storage may be 384 GB:

12000 SG (e.g., 6 Million CM/500 CM Per SG)*32 MB (per day)=3.84×10¹¹=384 GB of daily storage.

To reduce the amount of data being handled (and stored), each user device (e.g., endpoint) may process data (e.g., MER data) prior to sending the data to a server (e.g., a PNM server) for central processing and/or may notify the server if the user device detected a positive or negative RF event. The endpoint may process the MER data and report the data upon boot up or when there is a negative or positive RF event. The cable modem may perform, for example, second-by-second monitoring (or any other monitoring interval) of the MER (e.g., RxMER), and can determine a predictive modulation profile based on the MER data. The predictive modulation profile may be determined by using one or more methods that are similar to (or the same as) the methods described above for determining a modulation profile. The endpoint may perform these processes continuously, and/or off line and can report to the server when a significant change in fidelity is experienced. The server may collect the data upon startup of the CMTS and/or SG, and may place the new predictive bit-load profile, compare real-time data against other endpoints, and create a modulation profile that some, most, or all of the endpoints can support.

Several technological improvements may be attained. First, complexity of computation by one or more computing devices of the system may be reduced. Second, the need for data storage may be reduced. Third, the accuracy of generating modulation profiles may be improved. Fourth, the need for network polling of user devices may be reduced. Fifth, more control for determining implementation options may be available, and the need for implementation by third parties, such as vendors, may decrease.

The amount of data storage that may be saved may vary based on, e.g., a number of user devices served For example, monitoring may be performed once a day, and a serving group of 500 user devices and 12,000 serving groups total may be provided. For a worst case scenario (e.g., if every cable modem experiences a change in RF fidelity), each user device may process data (e.g., MER data) prior to sending the data to a server and may notify the server the negative RF event. Each user device experiencing the negative RF event may not send the data. Since the server does not receive the data and does not store about 96 GB of daily storage, about 96 GB storage space of the server may be saved—8 MB (e.g., 16 KB per CM*500 per SG)*12000 SG=96 GB of daily storage saving. If 10% of the cable modems experience RF fidelity issues, about 9.6 GB storage space of the server may be saved—0.8 MB (e.g., 16 KB per CM*50 per SG)*12000 SG=9.6 GB of daily storage saving. If 2% of the cable modems experience RF fidelity issues, about 1.92 GB storage space of the server may be saved—160 KB (e.g., 16 KB per CM*10 per SG)*12000 SG=1.92 GB of daily storage.

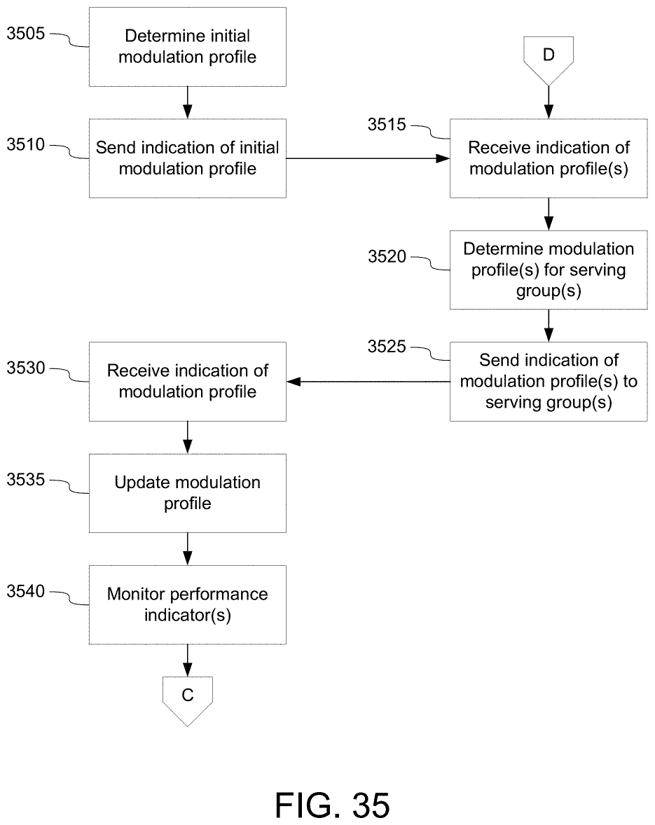

FIG. 35 shows at least a portion of a method for determining one or more data modulation profiles for a user device or a group of user devices. One or more steps may be added, omitted, and/or rearranged. In step 3505, a device (e.g., the user device or groups of user devices) may determine (e.g., estimate) an initial modulation profile using one or more of the concepts described above. For example, the device may estimate the initial modulation profile based on the MER, receive or transmit power, or any other metric of signal quality previously described. The initial modulation profile may comprise the device's determination of a best fit based on RF fidelity. The device may determine the initial modulation profile upon boot-up or sometime thereafter (e.g., 30 seconds after boot-up). In step 3510, the device may send an indication of the initial modulation profile to a server, such as a network management server.

In step 3515, the server may receive the indication of the initial modulation profile from the device. The server may similarly receive indications of initial modulation profiles from a plurality of other devices, such as devices in the same serving group (or not in the same serving group). In step 3520, the server may determine one or more modulation profiles, such as generic modulation profile, for one or more serving groups, which may be per OFDM channel. The server may determine the modulation profiles according to one or more of the concepts described above, such as shown in FIGS. 14 and 18-26. The server may assign each device to a particular modulation profile of the plurality of modulation profiles determined by the server. The server may attempt to assign the device to its initial modulation profile. The server may assign the device to a modulation profile different from its initial modulation profile. In step 3525, the server may send, to each device, an indication of its determined modulation profile. Devices in the same serving group may be assigned to the same modulation profile.

In step 3530, the device may receive, from the server, the indication of the modulation profile. In step 3535 and if applicable (e.g., the modulation profile is changed), the device may disregard its current modulation profile and accept the modulation profile assigned by the server. In step 3540, the device may monitor, such as during operation, certain performance indicator(s) (e.g., key performance indicators (KPI)) and use the monitoring to determine whether a new modulation profile might be needed. One example of a KPI is FEC.

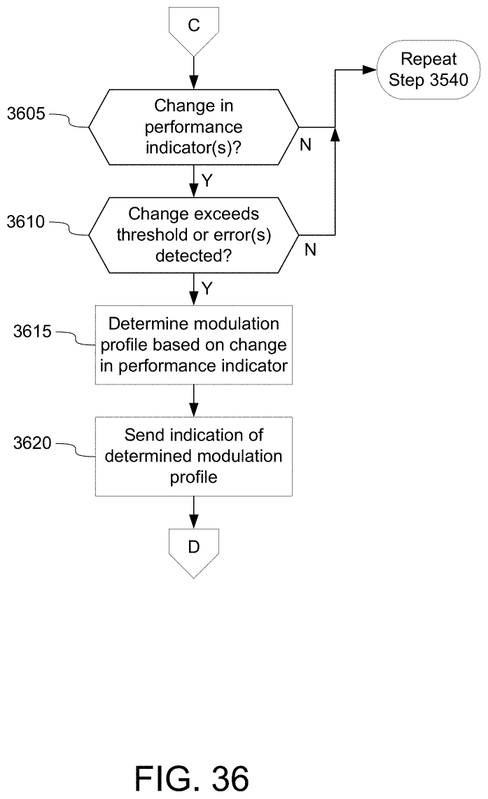

FIG. 36 shows at least a portion of a method for determining one or more data modulation profiles for a device or a group of devices. One or more steps may be added, omitted, and/or rearranged. In step 3605, based on monitored one or more performance indicator(s), such as FEC, a device may determine whether a change in modulation profile is warranted. If not (step 3605: N), the device may continue to monitor the performance indicator(s). If so (step 3605: Y), the device perform step 3610.

In step 3610, the device may determine whether the change in one or more performance indicator(s) exceeds a threshold and/or whether errors have been detected in data transmission or reception. The device may monitor its RF fidelity to determine whether to trigger an event for reevaluation of its modulation profile. If the change does not exceed the threshold (step 3610: N), the device may repeat step 3540 to monitor one or more performance indicator(s). If the change does exceed the threshold (step 3610: Y), the device may perform step 3615.

In step 3615, the device may determine a modulation profile based on the change in the performance indicator(s). How the device determines the modulation profile was previously described, and may be based on, for example, MER, received or transmitted power, and/or any other metric of signal quality. In step 3620, the device may send, to the server, an indication of the determined modulation profile. As previously described with reference to FIG. 35, the server may receive the indication and determine one or more updated modulation profiles for the device or other devices. A CM may monitor its KPI for non-errors and recalculate its suggested modulation profile for consideration for an improved modulation profile. The CM may monitor its KPI for errors and recalculate its suggested modulation profile for consideration for a more robust modulation profile.

As previously described, the user device and/or the network management server (e.g., a computing device) may determine a modulation profile based on a metric of signal quality, such as MER or received or transmitted power. The user device and/or the network management server may map either a single subcarrier MER or a range of contiguous MER subcarriers to a modulation profile (e.g., scheme) based on the number of subcarriers (e.g., to determine one or more modulation profiles).

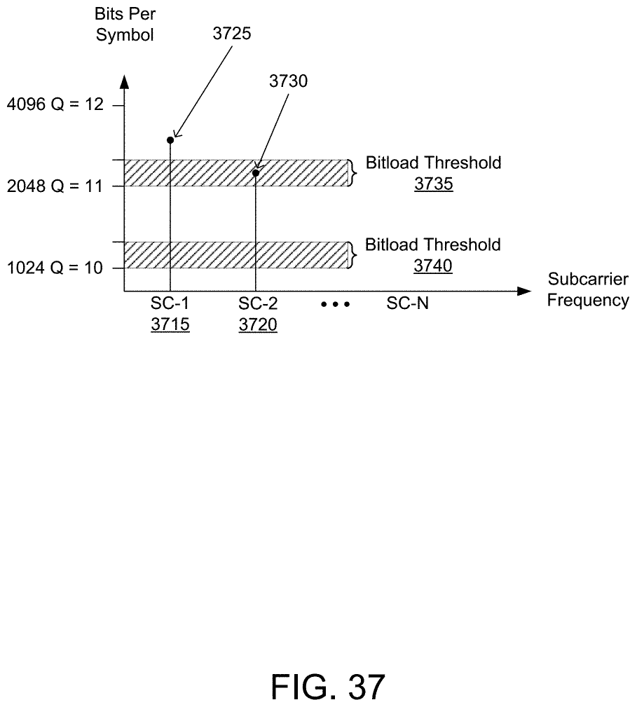

FIG. 37 shows an example of bitload thresholds. In a single subcarrier scenario, a computing device may determine the MER (e.g., MER 3725) for the subcarrier (MER_{SC}), such as SC-1 3715. The computing device may determine the raw bitload (Bitload_{Raw}) based on the MER_{SC}:

$${Bitload}_{Raw} = {Log}_{2} ( 1 + {10}^{\frac{{MER}_{SC}}{10}} )$$

The computing device may determine the bitload by using a floor function on the raw bitload:

Bitload=floor(Bitload_{Raw})

The computing device may calculate a bitload threshold (BitloadThreshold % ):

BitloadThreshold %=(Bitload_{Raw}−Bitload)*100

The computing device may compare the calculated bitload threshold with a set bitload threshold (e.g., a predetermined threshold), such as the bitload threshold 3735 or the bitload threshold 3740 shown in FIG. 37. Based on the comparison, the computing device may determine whether to leave the bitload according to the floor function or to decrease the bitload by 1. The following presents exemplary pseudo code for the comparison:

if(BT < SBT) {

Bitload = Bitload −1; // Decrease Bitload by 1

} else if (BT >= SBT) {

Bitload = Bitload; // No Change

}

By comparing the thresholds, the computing device may generate a safety or grace range to prevent losing data. The thresholds may be used so that an MER value is not too close to an edge of an MER spectrum graph. If the MER value falls below the MER at the edge, the MER value might no longer be discernable and data might be lost. As a result, the user device may avoid attempted use of a modulation order higher than it can support. The computing device may calculate the modulation order (and consequentially the modulation profile) as follows:

Modulation Order=2^{Bitload}

For example, if the bitload is 10, the modulation order may be 1024 QAM. If the bitload is 11, the modulation order may be 2048 QAM. If the bitload is 12, the modulation order may be 4096 QAM, and so forth. With reference to FIG. 37, a computing device may determine that the MER 3725 for a first subcarrier 3715 is above a bitload threshold 3735 (e.g., a threshold set at 40%). Accordingly, the computing device may determine to maintain the bitload for the first subcarrier 3715 at a bitload of 11 (and consequently a modulation order of 2048 QAM). The computing device may determine that the MER 3730 for a second subcarrier 3720 is not above the bitload threshold 3735 (e.g., 40%). Accordingly, the computing device may determine to reduce the bitload for the second subcarrier 3720 by 1. The second subcarrier 3720 may be assigned a bitload of 10 (and consequently a modulation order of 1024 QAM). Other bitloads may also have thresholds. For example, a bitload of 10 may have a bitload threshold 3740, which may be the same as the bitload threshold 3735 (e.g., 40%) or different from the bitload threshold 3735 (e.g., 10% or 50%).

Assume that the MER for the carrier is 36.9 dB. The computing device may determine the following:

$${Bitload}_{Raw} = {Log}_{2} ( 1 + {10}^{\frac{36.9}{10}} ) = 12.25$$

$$Bitload = floor ( 12.25 ) = 12$$

$$BitloadThreshold \% = ( 12.25 - 12 ) * 100 = 25 \%$$

In this example, assume that the predetermined bitload threshold is 40%. The computing device may determine to decrease the bitload by 1 because the calculated bitload threshold is less than the predetermined bitload threshold. Accordingly, the bitload may be set to 11, and the modulation order may be 2048 QAM.

The computing device may determine the number of subcarriers in the range based on the frequency band and the subcarrier spacing. An example of a frequency band of 1 MHz and a subcarrier spacing of 50 KHz may be used:

$$\frac{OFDM Frequency Band ( Hz )}{Subcarrier Spacing ( Hz )} = \frac{1000000}{50000} = 20 Subcarriers$$

The computing device may calculate a sum of the standard deviations across each subcarrier in the frequency band:

$${\sum }_{i = 0}^{n = 20} SD ( {MER}_{Sub} [ i ] )$$

where i=subcarrier index; MER_{Sub}=MER Per Sub Carrier; SD=Standard Deviation or Statistical Descriptive Function

The computing device may calculate the mean MER:

μ=MER_{Mean}

The computing device may also calculate the MER value any number of standard deviations from the mean, such as three standard deviations from the mean:

−3σ=99.37% Coverage

M̅E̅R̅=(μ−3σ)

The computing device may determine the bitload and bitload threshold according to the algorithms described above. For example:

$${Bitload}_{Raw} = {Log}_{2} ( 1 + {10}^{\frac{\overline{MER}}{10}} )$$

$$Bitload = floor ( {Bitload}_{Raw} )$$

$$BitloadThreshold \% = ( {Bitload}_{Raw} - Bitload ) * 100$$

The computing device may compare the calculated bitload threshold with a set bitload threshold (e.g., a predetermined threshold). Based on the comparison, the computing device may determine whether to leave the bitload according to the floor function or to decrease the bitload by 1. The following presents exemplary pseudo code for the comparison:

if(BT < SBT) {

Bitload = Bitload −1; // Decrease Bitload by 1

} else if (BT >= SBT) {

Bitload = Bitload; // No Change

}

The computing device may calculate, based on the bitload, the modulation order (and consequentially the modulation profile) as follows:

Modulation Order=2^{Bitload}

Assume that the M̅E̅R̅=36.5 dB. The computing device may determine the following:

Bitload_{Raw}=Log₂(1+10^{36.5}^{_{/10}})=12.12

Bitload=floor(12.12)=12

BitloadThreshold %=(12.12−12)*100=12%

In this example, assume that the predetermined bitload threshold is 5%. The computing device may determine to maintain the bitload at 12 because the calculated bitload threshold is not less than the predetermined bitload threshold. Accordingly, the modulation order may be calculated as 4096 QAM.

As previously described, one or more user devices may calculate the modulation order and send the suggested modulation order to a network management server. The network management server may receive suggested modulation orders from a plurality of devices and recalculate the modulation orders if necessary.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
determining, by a computing device and based on a received signal and on a first profile, estimated channel conditions;
determining second profile data associated with transmission based on the estimated channel conditions and on a second profile different from the first profile;
sending, to a second computing device, the second profile data; and
receiving, after sending the second profile data, a second signal modulated based on the second profile.

2. The method of claim 1, further comprising:
predicting, based on the first profile, occurrence of an error, wherein the determining the second profile data is performed based on the predicting.

3. The method of claim 1, wherein the determining the second profile data comprises simulating transmission, based on the estimated channel conditions and on the second profile, of a test signal.

4. The method of claim 1, further comprising:
determining a second bit stream by simulating transmission, based on the estimated channel conditions, of a first bit stream converted based on the first profile; and
sending, based on the first bit stream and on the second bit stream, a prediction result associated with the first profile,
wherein the second signal is received after sending the prediction result.

5. The method of claim 1, wherein the determining the second profile data comprises:
generating, based on a first bit stream, a test signal;
determining, based on the test signal, on the second profile, and on the estimated channel conditions, a second bit stream; and
determining, based on the first bit stream and the second bit stream, the second profile data.

6. The method of claim 1, wherein the second profile data comprises a bit error ratio.

7. The method of claim 1, wherein the determining the second profile data comprises:
determining, based on simulating transmission of a test signal, a simulated evaluation parameter; and
comparing the simulated evaluation parameter with a threshold value.

8. The method of claim 1, further comprising:
determining, based on the received signal, one or more evaluation parameters; and
adjusting, based on the one or more evaluation parameters, one or more simulation configurations,
wherein the determining the second profile data is further based on the adjusted one or more simulation configurations.

9. The method of claim 1, wherein the second profile data indicates a request for replacement of the first profile with the second profile.

10. The method of claim 1, wherein the second profile comprises one of more of:
a second encoding profile different from a first encoding profile of the first profile; or
a second modulation profile different from a first modulation profile of the first profile.

11. A method comprising:
predicting, by a computing device and based on a first profile, occurrence of an error;
determining, based on the predicting, second profile data associated with transmission based on estimated channel conditions and on a second profile different from the first profile;
sending, to a second computing device, the second profile data; and
receiving, after sending the second profile data, a signal modulated based on the second profile.

12. The method of claim 11, wherein the determining the second profile data comprises:
generating, based on a first bit stream, a test signal;
determining, based on the test signal, the second profile, and the estimated channel conditions, a second bit stream; and
determining, based on the first bit stream and on the second bit stream, the second profile data.

13. The method of claim 11, wherein the determining the second profile data comprises simulating transmission, based on the estimated channel conditions and on the second profile, of a test signal.

14. The method of claim 11, wherein the second profile data comprises a bit error ratio.

15. The method of claim 11, wherein the second profile data indicates a request for replacement of the first profile with the second profile, and
wherein the second profile comprises one of more of:
a second encoding profile different from a first encoding profile of the first profile; or
a second modulation profile different from a first modulation profile of the first profile.

16. A method comprising:
determining, by a computing device and based on a received signal and on a first profile, estimated channel conditions;
determining a second bit stream by simulating transmission, based on the estimated channel conditions, of a first bit stream converted based on the first profile;
determining, based on the first bit stream and on the second bit stream, a prediction result associated with the first profile; and
receiving, after sending the prediction result to a second computing device, a second signal modulated based on a second profile different from the first profile.

17. The method of claim 16, further comprising:
determining, based on comparing the first bit stream and the second bit stream, a bit error ratio, wherein the prediction result is based on the bit error ratio.

18. The method of claim 16, further comprising:
determining, based on the first bit stream and on the second bit stream, a bit error ratio;
comparing the bit error ratio with a threshold value; and
determining, based on the comparing, the prediction result.

19. The method of claim 16, further comprising:
simulating transmission, based on the estimated channel conditions, of a third bit stream converted based on the second profile, and
sending, to the second computing device, second profile data determined based on the simulating transmission of the third bit stream.

20. The method of claim 16, wherein the second profile comprises one of more of:
a second encoding profile different from a first encoding profile of the first profile; or
a second modulation profile different from a first modulation profile of the first profile.
